(19) United States
(12) Patent Application Publication
(10) Pub. No.: US 2026/0359293 A1
(43) Pub. Date: Nov. 12, 2026

(54) ARTIFICIAL INTELLIGENCE-DRIVEN QUERYING OF HIERARCHICAL DATA

(71) Applicant: Cisco Technology, Inc., San Jose, CA (US)

(72) Inventors: Viktor Mats Emanuel Leijon, San Jose, CA (US); Sahithi Patibandla, Newark, CA (US)

(21) Appl. No.: 19/200,252

(22) Filed: May 6, 2025

(51) Int. Cl. G06F 16/2452; G06F 16/28; G06F 16/334

(52) U.S. Cl. CPC G06F 16/24522; G06F 16/282; G06F 16/3347

(57) ABSTRACT

Devices and methods for Artificial Intelligence (AI)-driven querying of hierarchical data are provided. An AI-driven device summarizes a hierarchical data model, performs semantic augmentation, generates an augmented query, and output the augmented query or a search result based on the augmented query. The AI-driven device flattens a hierarchical data model into a plurality of linear paths, augments the linear paths with semantic data derived from the hierarchical data model, and encodes the augmented linear paths into a set of vector representations for storage in a knowledge base. The AI-driven device receives a query in natural language, converts the query into query vector, and retrieves one or more of the stored vector representations from the knowledge base based on the query vector. The AI-driven device, using Large Language Model (LLM), generates an augmented query in a hierarchical query language associated with the hierarchical data model based on the retrieved vector representations.

The present disclosure relates to Artificial Intelligence (AI) systems. More particularly, the present disclosure relates to AI-driven querying of hierarchical data.

### BACKGROUND

Large Language Models (LLMs) have evolved from early language-processing techniques into Artificial Intelligence (AI) systems that are reshaping digital communication and content creation. The development of LLMs began with Natural Language Processing (NLP) research. However, modern LLMs have emerged recently, driven by advancements in deep learning and neural networks architectures. The introduction of the transformer architecture marked a pivotal shift, enabling the LLMs to efficiently capture complex dependencies and contextual relationships in text. LLMs have progressively advanced the capabilities of natural language understanding and generation.

The use of Retrieval-Augmented Generation (RAG) frameworks has grown significantly. RAG techniques enhance the quality, accuracy, and relevance of LLM outputs by enriching input prompts with external contextual information retrieved from structured or unstructured data sources. A common application of RAG is in question answering over data repositories, where a natural language query provided by a user is used to retrieve relevant data such as documents, facts, or passages from a knowledge base. The retrieved data is then fed into the LLM prompt to generate a response. However, performance of LLMs may be influenced by characteristics of the data sources, including their quality, diversity, and relevance.

### SUMMARY OF THE DISCLOSURE

Systems and methods for Artificial Intelligence (AI)-driven querying of hierarchical data in accordance with embodiments of the disclosure are described herein. In many embodiments, a device comprises one or more processors, and a memory communicatively coupled to the one or more processors. The memory comprises a query management logic and a hierarchical data model including a plurality of nodes. The query management logic is configured to flatten the hierarchical data model into a plurality of linear paths, augment the plurality of linear paths with semantic data, encode one or more augmented linear paths of the augmented plurality of linear paths into a set of vector representations, and store the set of vector representations in a knowledge base.

In a number of embodiments, the query management logic is further configured to recursively traverse the hierarchical data model to flatten the hierarchical data model into the plurality of linear paths.

In a variety of embodiments, a linear path of the plurality of linear paths represents a unique traversal from a root node to a terminal node of the hierarchical data model. The plurality of nodes comprises the root node and the terminal node.

In various embodiments, to augment the plurality of linear paths with the semantic data, the query management logic is further configured to derive the semantic data from the hierarchical data model.

In more embodiments, the semantic data comprises at least one of, node descriptions, node metadata, or hierarchical node positions, of the plurality of nodes.

In additional embodiments, the node metadata comprises at least one of, node types, data types, operational attributes, and configuration flags, of the plurality of nodes.

In further embodiments, the knowledge base corresponds to an embedding vector database.

In still more embodiments, the query management logic is further configured to receive a natural language query, convert the natural language query into a query vector, retrieve one or more vector representations from the set of vector representations stored in the knowledge base based on the query vector, and identify, based on the retrieved one or more vector representations, at least one linear path of the plurality of linear paths and at least one augmented linear path of the augmented plurality of linear paths, corresponding to the received natural language query.

In still further embodiments, the query management logic is further configured to generate, via a large language model, an augmented query in a hierarchical query language associated with the hierarchical data model based on the received natural language query and at least one of the identified at least one linear path or the identified at least one augmented linear path.

In still additional embodiments, the query management logic is further configured to output the augmented query in the hierarchical query language in response to the received natural language query.

In some more embodiments, the query management logic is further configured to output, based on the augmented query, a search result from the hierarchical data model for the received natural language query.

In yet various embodiments, the query management logic is further configured to search the hierarchical data model based on the augmented query, and output a search result for the received natural language query based on the search.

In yet more embodiments, a device comprises one or more processors, and a memory communicatively coupled to the one or more processors. The memory comprises a query management logic and a hierarchical data model. The query management logic is configured to receive a natural language query, convert the natural language query into a query vector, retrieve one or more vector representations from a knowledge base based on the query vector, wherein the one or more vector representations correspond to a set of semantically augmented linear paths of the hierarchical data model, and generate, via an artificial intelligence-based model (AI-based model), an augmented query in a hierarchical query language associated with the hierarchical data model based on the set of semantically augmented linear paths and the received natural language query.

In still yet more embodiments, to generate the augmented query, the query management logic is further configured to identify the set of semantically augmented linear paths based on the retrieved one or more vector representations.

In many further embodiments, the AI-based model corresponds to a large language model.

In many additional embodiments, the query management logic is further configured to output the augmented query in the hierarchical query language in response to the received natural language query.

In still yet further embodiments, the query management logic is further configured to output, based on the augmented query, a search result from the hierarchical data model for the received natural language query.

In still yet additional embodiments, the query management logic is further configured to search the hierarchical data model based on the augmented query, and output a search result for the received natural language query based on the search.

In several embodiments, a method comprises flattening a hierarchical data model into a plurality of linear paths, augmenting the plurality of linear paths with semantic data, encoding one or more augmented linear paths of the augmented plurality of linear paths into a set of vector representations, and storing the set of vector representations in a knowledge base.

In several more embodiments, the method further comprises receiving a natural language query, converting the natural language query into a query vector, retrieving one or more vector representations from the set of vector representations stored in the knowledge base based on the query vector, identifying, based on the retrieved one or more vector representations, at least one linear path from the plurality of linear paths and at least one augmented linear path of the augmented plurality of linear paths, corresponding to the received natural language query, and generating, via a large language model, an augmented query in a hierarchical query language associated with the hierarchical data model based on the received natural language query and at least one of the identified at least one linear path or the identified at least one augmented linear path.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram illustrating various subsets of artificial intelligence in accordance with various embodiments of the disclosure;

FIG. 2 is a block diagram illustrating different methods of machine-based learning in accordance with various embodiments of the disclosure;

FIG. 3 is a block diagram illustrating a machine learning lifecycle in accordance with various embodiments of the disclosure;

FIG. 4 is a schematic diagram illustrating an example neural network in accordance with various embodiments of the disclosure;

FIG. 5 is a schematic diagram illustrating a system architecture for Artificial Intelligence (AI)-driven querying of hierarchical data in accordance with various embodiments of the disclosure;

FIG. 6 is a block diagram illustrating a Large Language Model-driven query management device in accordance with various embodiments of the disclosure;

FIG. 7 is a diagram illustrating an example hierarchical data model and a corresponding linear path in accordance with various embodiments of the disclosure;

FIG. 8 is a flowchart depicting a process for summarizing a hierarchical data model in accordance with various embodiments of the disclosure;

FIG. 9 is a flowchart depicting a more-detailed process for summarizing a hierarchical data model in accordance with various embodiments of the disclosure;

FIG. 10 is a flowchart depicting a process for generating an augmented query in a hierarchical query language from a natural language query in accordance with various embodiments of the disclosure;

FIG. 11 is a flowchart depicting a process for generating an augmented query associated with a query management device in accordance with various embodiments of the disclosure; and

FIG. 12 is a conceptual block diagram of a device suitable for configuration with a query management logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems and methods are discussed herein for Artificial Intelligence (AI)-driven querying of hierarchical data. In one or more embodiments, an artificial intelligence-based system can range from simple rule-based programs to sophisticated models capable of learning, adapting, and making data-based decisions. AI spans across various applications, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is increasingly embedded in powering applications from personal assistants to autonomous vehicles and even aiding scientific research and complex problem-solving.

Machine learning (ML) is a subset of AI that involves systems learning from data to make predictions or decisions without being explicitly programmed for each task. Unlike traditional software, which relies on hard-coded rules, machine learning systems use algorithms that identify patterns and adjust behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML is the foundation for many modern AI applications, enabling systems to generalize from data and improve over time. As such, ML systems are central to developing more advanced AI models and applications, including those requiring nuanced understanding, such as image recognition and language processing.

LLMs may represent a specific application of machine learning within AI, focused on understanding and generating human language. Positioned within the broader field of Natural Language Processing (NLP), LLMs utilize advanced machine learning architectures, particularly deep learning and transformer models, to process vast amounts of text data. Through this training, LLMs may develop the ability to capture context, generate coherent responses, and perform complex language-based tasks in a range of applications, from chatbots to content creation and data analysis.

With the increasing use of LLMs for natural language processing tasks, there has been a corresponding surge in the development and application of Retrieval-Augmented Generation (RAG) techniques. RAG techniques enhance input prompts by incorporating contextually relevant information retrieved from external data sources. While significant progress has been made in leveraging data sources with flat or unstructured representations, data sources characterized by hierarchical, tree-structured schemas remain comparatively underutilized. Examples of such schemas include Yet Another Next Generation (YANG), Extensible Markup Language (XML) Schema, and JavaScript Object Notation (JSON) schema, which define data in nested, tree-like structures. Interacting with these hierarchical models typically requires in-depth knowledge of the schema and the manual formulation of path-based queries using domain-specific query languages. However, RAG-based systems often exhibit limited effectiveness in accurately translating natural language queries into executable, structured queries compatible with such hierarchical data representations.

To address these challenges, the present disclosure provides an AI-driven device that may flatten a hierarchical data model into a set of linear paths. Each linear path may represent a complete traversal from a root node to a terminal node within a schema. The linear paths may be augmented with semantic data, including but not limited to node descriptions, data types, operational attributes, contextual relationships, or the like. The result may be a set of semantically augmented linear paths that form the foundation for mapping natural language queries to structured queries.

Each augmented linear path may be encoded into a vector representation using a transformer-based embedding model. The vector representations may be stored in a vectorized knowledge base, enabling fast and accurate search (for example, similarity search). When a user submits a natural language query, the AI-driven device may convert the natural language query into a query vector and perform a semantic retrieval operation against the stored vector representations (for example, linear path embeddings) to identify the most relevant segments of the hierarchical data model.

In many embodiments, an LLM may generate an augmented query in a hierarchical query language. The generation of the augmented query may be based on the retrieved vector representations and the user's original query (for example, the natural language query). The LLM may interpret the user's intent, integrate schema-specific path details, and construct a machine-readable, executable augmented query aligned with the structure and rules of the underlying hierarchical data model. The final output may be validated, displayed, or directly submitted to a target backend for query execution or data extraction. In a number of embodiments, the AI-driven device may convert or translate unstructured natural language into rigid structured data, enabling users to interact with complex schema-driven systems.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electric current. In many further embodiments, a circuit may include a return pathway for electric current, so that the circuit is a closed loop. In many additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In still yet further embodiments, a circuit may include a portion of an integrated circuit, an integrated circuit, a set of integrated circuits, a set of non-integrated electrical and/or electrical components with or without integrated circuit devices, or the like. In still yet additional embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in several embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

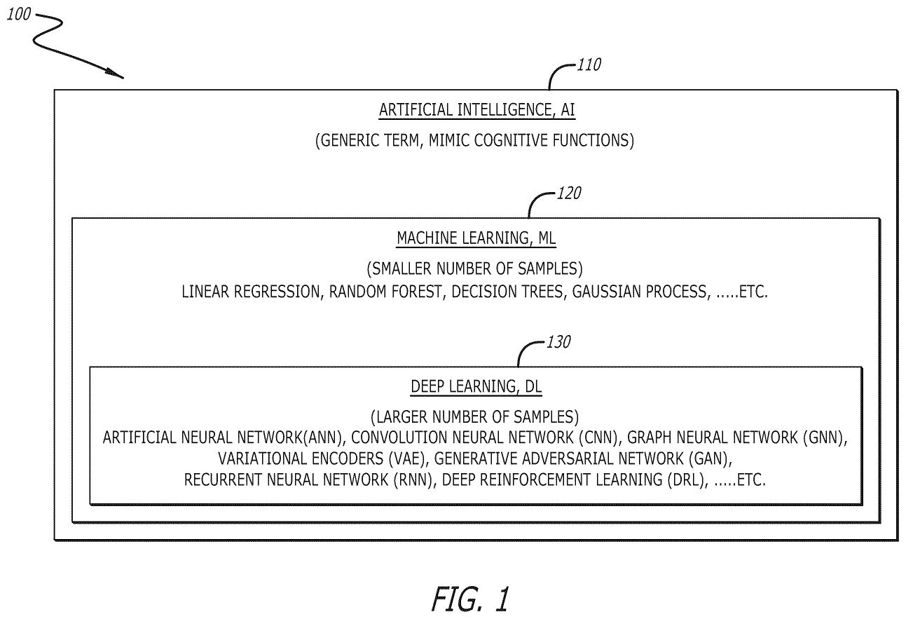

Referring to FIG. 1, a schematic diagram 100 illustrating various subsets of artificial intelligence in accordance with various embodiments of the disclosure is shown. Artificial intelligence (AI) 110 is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike conventional computer programs that follow a fixed set of instructions, AI systems can adapt, improve, and make decisions based on input data and environmental interactions.

AI 110 can be considered a generic term because AI 110 encompasses a wide range of subfields and techniques, from simple rule-based systems to advanced machine learning and deep learning models. These AI techniques are utilized for simulating various aspects of human cognition. For example, Machine Learning (ML) 120 allows computers to learn from data patterns without explicit programming for each task, while Natural Language Processing (NLP) enables machines to understand and generate human language. Deep learning (DL) 130, a more advanced branch of AI 110, utilizes neural networks to automatically learn complex patterns from large datasets, akin to information processing by the human brain. This versatility makes AI 110 a powerful tool across diverse applications, including network event classification, anomaly analysis, image recognition, autonomous driving, voice assistants, network diagnostics, and materials discovery.

A goal of AI 110 is often to create systems that can function autonomously and intelligently in real-world scenarios. As AI 110 continues to evolve, AI 110 can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 120 is a subset of AI 110 that focuses on the development of algorithms and statistical models that enable computers to learn and make decisions from data without explicit programming. In conventional programming, a computer is given a fixed set of rules to follow, but ML 120 can shift this paradigm by allowing systems to identify patterns, adapt, and improve their performance based on the data they encounter. This data-driven approach makes ML 120 particularly valuable for tasks that are too complex or dynamic to define using straightforward rules, such as determining patterns associated with network events, recognizing images, predicting consumer behavior, or diagnosing network problems. In various embodiments described herein, machine-learning methods may be utilized for generating an augmented query in a hierarchical query language, outputting the augmented query, searching a hierarchical data model based on the augmented query, and/or outputting a search result from the hierarchical data model.

ML models can be configured to analyze large amounts of data to identify trends and relationships that inform their predictions or classifications. The process typically involves three stages: training, validation, and testing. During training, the ML model learns from a dataset by adjusting its internal parameters to minimize errors between its predictions and the actual results. Techniques such as linear regression, decision trees, random forests, and Gaussian processes are commonly utilized in ML 120. These algorithms can handle various data types, including numerical, categorical, and structured datasets such as spreadsheets or grids. One of the strengths of ML 120 is its ability to generalize from training data to make accurate predictions on new, unseen data. In many embodiments described herein, training data may be generated from historical queries, augmented plurality of linear paths, vector representations corresponding to the augmented plurality of linear paths, among other sources.

However, conventional ML methods may rely heavily on feature engineering, wherein human experts manually identify the most relevant features or patterns within the data. For example, when using ML 120 for classifying network events, an expert may need to extract features such as header characteristics, payload characteristics, temporal characteristics, protocol type, packet count, context, domain, connection states, or the like, before feeding them into the ML model. This requirement can limit the scalability of conventional ML approaches, especially when dealing with large, unstructured datasets such as images, text, or graphs. Additionally, ML algorithms may often work best when provided with relatively structured data, and they often need a reasonable number of samples (typically more than 100) to learn effectively.

DL 130 is a specialized subset of ML 120 that employs multi-layered artificial neural networks to automatically learn complex patterns and representations from large, often unstructured datasets. Inspired by the way the human brain processes information, DL 130 includes interconnected layers of “neurons” that can adaptively change as they are exposed to more data. Unlike conventional ML methods, which require manual feature engineering to identify data characteristics, DL models can automatically extract features directly from raw data, such as images, text, or data structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as network traffic, network structures, atomic interactions, loads, or the like. GNNs can learn the dependencies and relationships within graph-like structures, which may facilitate predicting properties of complex patterns, network traffic, and materials. For example, the features of the network events are modeled as a graph and may be input into a GNN for classifying the network events as normal or legitimate network events, critical network events, or anomalous network events. By organizing the features of the network events into a graph structure, situations where new or unseen patterns generated by newly developed or updated applications, referred to as “zero-day” applications, are unknown, may be handled optimally. RNNs and their variants, such as Long Short-Term Memory (LSTM) networks, are suited for sequential data such as time series or NLP, allowing for the analysis and generation of textual information or the prediction of temporal patterns in scientific research.

One of the defining characteristics of DL 130 is its requirement for large datasets (typically over 500 samples for example) to effectively train neural networks. While the deep, multi-layered structure of these networks enables them to capture highly complex and abstract representations of the data, they also demand significant computational power. Techniques such as Variational Autoencoders (VAEs) and Generative Adversarial Networks (GANs) add to the versatility of DL 130 by enabling the generation of new data samples that resemble a training dataset, aiding in areas such as materials discovery and synthetic data creation. Deep Reinforcement Learning (DRL) combines neural networks with decision-making processes to solve problems that involve optimization and control, further expanding the application potential of DL 130. In summary, the ability of DL 130 to automatically learn from raw, unstructured data and model intricate patterns makes DL 130 a powerful tool in AI 110, particularly for complex domains such as image recognition, NLP, and materials science.

Artificial Neural Networks (ANNs or sometimes merely NNs) are often a foundation of a DL system. The basic unit of a neural network is typically a perceptron, which can take inputs, assign weights to these inputs, and combine them to produce an output. The final output is then passed through an activation function, for example, a Rectified Linear Unit (ReLU), a sigmoid, or a hyperbolic tangent, to introduce non-linearity, which enables the network to model complex patterns.

Neural networks are typically trained through a process of backpropagation, where predictions of an AI system are compared against a known output, and a loss function is utilized to measure the difference between the prediction and the actual result. The weights assigned by the neural network can be adjusted through a process called gradient descent, which can be configured to minimize the loss function over time. However, the training process can be prone to problems such as overfitting (where the ML model performs well on the training data but poorly on new data). To counter this, techniques such as regularization (e.g., dropout), early stopping, and mini-batches can be utilized to prevent the neural network from becoming overly specialized to the training dataset.

CNNs are a specific type of ML neural network designed to work particularly well with image data, making them highly relevant for AI-based query management devices for queries related to image data. As those skilled in the art will recognize, CNNs typically utilize specialized layers known as convolutional layers, which apply filters (also known as kernels) to the input data. These filters slide over the input (e.g., an input power value), detecting patterns such as edges or textures, which are then passed to the next layer for further processing. CNNs can automatically learn and extract relevant features from raw data without the need for manual feature engineering. Furthermore, pooling layers (e.g., max-pooling or average pooling) are often added after convolutional layers to reduce the dimensionality of the data, helping to make the AI system more efficient while retaining the most important information. After several layers of convolutions and pooling, the CNN can output a search result, for example, classifying an image.

While CNNs are well-suited for grid-based data like images, many real-world problems can involve non-grid data, such as financial transaction or network configurations. This type of data may better be represented as a graph or a hierarchical graphs, where nodes represent entities (e.g., network devices, Internet Protocol “IP” addresses, applications, or the like) and edges represent relationships between them (e.g., communication patterns or data flows between the network devices and the applications). Thus, Graph Neural Networks (GNNs) can be utilized to operate on such graph-based data.

In GNNs, information is passed between the nodes through the edges in a process called message passing. This allows the neural network to capture dependencies and relationships within the graph structure. GNNs can aggregate information from neighboring nodes, which is utilized in predicting properties that depend on the current/local structure, such as the behavior of nodes of the AI-based query management devices.

Generative models aim to learn the underlying distribution of a dataset and generate new samples that resemble the original data. Two common types of generative models are VAEs and GANs. VAEs are often configured to work by encoding data into a lower-dimensional latent space and then decoding the data back into its original form, which allows for the generation of new data by sampling points from the latent space. This can be utilized when attempting to process a natural language query. Similarly, GANs include two components: a generator that creates fake or generated data and a discriminator that attempts to distinguish between real data and fake data. The two components are trained in a competitive process where the generator attempts to “fool” the discriminator, leading to increasingly realistic generated data. This type of process may be utilized to detect vulnerabilities in a system such as communication network.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex network event simulations.

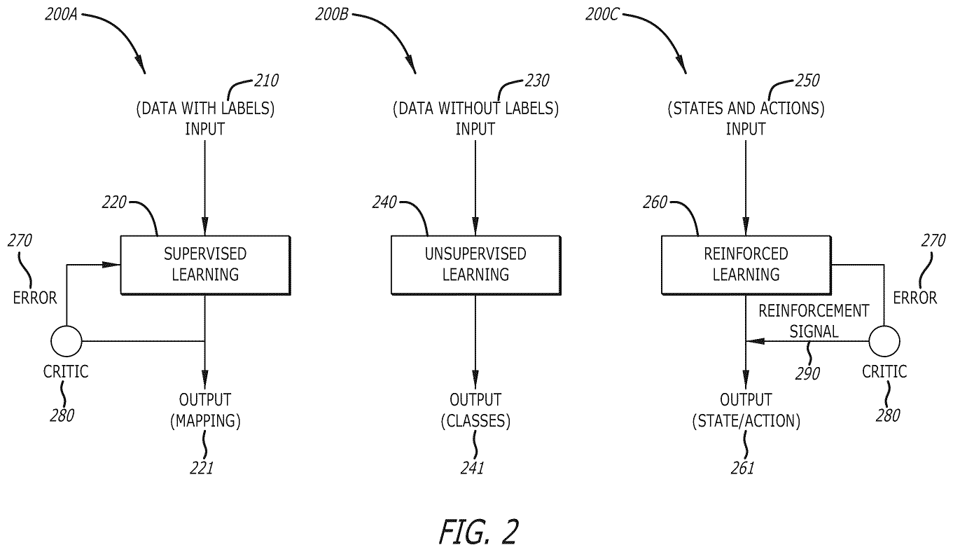

Although a specific embodiment for various subsets of artificial intelligence suitable for carrying out the various steps, processes, methods, and operations described herein is discussed with respect to FIG. 1, any of a variety of systems and/or processes may be utilized in accordance with embodiments of the disclosure. For example, another subset, such as transformer networks, capsule networks, or the like, may be present and available for use within AI 110. Those skilled in the art will recognize that the schematic diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-12 as required to realize a particularly desired embodiment.

Referring to FIG. 2, a block diagram illustrating different methods of machine-based learning in accordance with various embodiments of the disclosure is shown. In many embodiments, an ML model is defined as a mathematical representation of an output of a training process. An ML model is often considered similar to computer software designed to recognize patterns or behaviors based on previous experience or data. An ML algorithm can discover patterns within training data, and output an ML model which can capture these patterns and make predictions on new data.

ML models may be interpreted as devices that have been trained to find patterns within new data and make predictions. These ML models can be represented as complex mathematical functions that would be impractical for a human to calculate, that takes requests in the form of input data, makes predictions on input data, and then provides an output in response. These ML models can be trained over a set of data, and then they may be provided an algorithm or other task to reason over the data, extract patterns from feed data, and learn from that data. Once the ML models are trained, they can be utilized to predict a new and previously unseen dataset.

There are various types of ML models available based on different business goals and datasets available. Often, based on the desired application, ML models can be configured as or settled into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates output data 221. The output data 221 is often reviewed by a critic 280 that can determine an error 270 that is fed back into the supervised learning model 220 for use in updating.

Supervised learning systems 200A are often considered the simplest ML model to understand which input data (such as training data) has a known label or result as an output. The supervised learning model 220 can, therefore, be understood to work on the principle of input-output pairs. As such, a function can be trained using a training dataset, which is then applied to unknown data to make some predictions. Supervised learning is task-based and mostly tested on labeled datasets.

Supervised learning systems 200A may often involve one or more regression problems. In regression problems, the output is a continuous variable. Examples of commonly utilized regression models include linear regression, decision trees, and random forests. Linear regression is typically the most straightforward ML model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this linear equation may be represented in the form of a line: y=bx+c. A typical aim of a linear regression-based model can be to find an optimal fit line that best fits available data points. Linear regression can be extended to multiple linear regressions (finding a plane of best fit in a higher dimensional space) and polynomial regressions (finding the best fit curve).

Decision trees are also popular ML models that can be utilized for both regression and classification problems. A decision tree utilizes a tree-like structure of decisions along with their possible consequences and outcomes. In a decision tree, each internal node is utilized to represent a test on an attribute while each branch is utilized to represent the outcome of the test. The more nodes a decision tree has, the more accurate the result will be. This may be utilized when making decisions related to natural language queries. Decision trees are intuitive and easy to implement, but may lack accuracy depending on computational or time resources available.

Random forests are an ensemble learning method, which may include a large number of decision trees. For example, each decision tree in a random forest predicts an outcome, and the prediction with a majority of votes is considered as the outcome. A random forest model can be utilized for both regression and classification problems. For a classification task, the outcome of the random forest may be taken from the majority of votes. Whereas in a regression task, the outcome can be taken from a mean or an average of the predictions generated by each tree.

Classification models are the other type of supervised learning, which can be utilized for generating conclusions from observed values in one or more categorical forms. For example, a classification model can identify if an email is spam or not; whether a search result is accurate etc. Classification algorithms can also be utilized for predicting between two or more classes and/or categorize an output into different groups. For these classification systems, a classification model can be designed that classifies a dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be utilized for solving various classification problems in machine learning systems. These processes are similar to linear regression but are often utilized for predicting categorical variables. While some variations can be configured to generate a prediction as an output in either “yes” or “no,” 0 or 1, “true” or “false,” etc., in a number of embodiments, the system can instead be configured to not give exact values, but instead provide probabilistic values between zero and one.

Another classification process that can be utilized is a Support Vector Machine (SVM) which is widely utilized for classification and regression tasks. However, the main aim of the SVM is to find the best decision boundaries in an N-dimensional space, which can be utilized for segregating data points into classes, and generate a best decision boundary often known as a hyperplane. SVM processes can select an extreme vector to find a hyperplane, wherein this vector is known as a support vector.

Naïve Bayes is another popular classification algorithm utilized in machine learning. This classification process is based on Bayes' theorem and follows a naive (independent) assumption between features which is often based on the following formula:

$$P ( y \vert X ) = \frac{{P ( X \vert y )}^{*} P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as a posterior chance being a result of prior results times the likelihood divided by evidence available. Each Naïve Bayes classifier assumes that the value of a specific variable is independent of any other variable/feature. For example, if a fruit needs to be classified based on color, shape, and taste, yellow, oval, and sweet will be recognized as mango. In this example, each feature is independent of other features. Likewise, various embodiments herein can classify based on a type of query, domain of the query, etc.

Further, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. Unsupervised learning models 240 can implement a learning process opposite to supervised learning, which means the learning process enables a model to learn from an unlabeled training dataset. Based on the unlabeled training dataset, the unsupervised learning model 240 can predict the output 241. Using the unsupervised learning system 200B, the unsupervised learning model 240 can learn hidden patterns from the unlabeled training dataset by itself without any supervision. In a variety of embodiments, unsupervised learning models 240 are often utilized for performing tasks involving clustering, association rule learning, and/or dimensional reduction.

Clustering is an unsupervised learning technique that involves clustering or grouping the available data points into different clusters based on similarities and/or differences. The data points or objects with the most similarities remain in the same group, and they have no or very few similarities from other groups. Clustering algorithms can be utilized in various tasks such as, but not limited to, image segmentation, statistical data analysis, market segmentation, or the like. Some commonly utilized clustering algorithms that can be selected include, for example, K-means clustering, hierarchal clustering, Density-based Spatial Clustering of Applications with Noise (DBSCAN), etc.

Association rule learning is an unsupervised learning technique which finds unique relations among variables within a large dataset. In various embodiments, a primary aim of this type of learning algorithm is to find a dependency of one data item on another data item and map those variables accordingly to satisfy a desired outcome. For example, in more embodiments, an association rule system may be utilized to enable flattening of hierarchical schemas into a linear format. This learning algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and Frequent Pattern (FP)-growth algorithm.

In additional embodiments, the number of features/variables present in a dataset can be understood as the dimensionality of the dataset, and the technique utilized to reduce the dimensionality is known as a dimensionality reduction technique. Although more data provides more accurate results, more data can also affect the performance of the model/algorithm, for example, by yielding overfitting outcomes. In such cases, dimensionality reduction techniques can be utilized. Dimensionality reduction techniques involve converting a higher-dimensional dataset into a lower-dimensional dataset while also ensuring that the ensuing results provide similar information. Different dimensionality reduction methods can be utilized, such as, but not limited to, Principal Component Analysis (PCA), Singular Value Decomposition (SVD), etc.

Further, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice an error 270 within the reinforcement learning model 260 actions, and transmit a reinforcement signal 290 to adjust the outcome/output such that the “reward” or “punishment” is adjusted to better model the future behaviors or processing of the reinforcement learning model 260.

The reinforcement learning model 260 is a feedback-based learning model that can take feedback signals after each state or action by interacting with the environment. This feedback works as a reward (positive for each good action and negative for each bad action), and an AI agent's goal is to maximize the positive rewards to improve their performance. The behavior of the reinforcement learning model 260 in reinforcement learning is similar to that of human learning, as humans learn things by experiences as feedback and interact with an environment. Popular methods of reinforcement learning include Q-learning, State-Action-Reward-State-Action (SARSA), and deep Q network.

Q-learning is one of the popular model-free algorithms of reinforcement learning, which is based on the Bellman equation. Q-learning often aims to learn a policy that can help an AI agent to take the best action for maximizing a reward under a specific circumstance. Q-learning can incorporate a Q-value for each state-action pair that indicates the reward to following a given state path, and tries to maximize that Q-value.

SARSA is an on-policy algorithm based on the Markov decision process. In further embodiments, SARSA can use the action performed by the current policy to learn the Q-value. The SARSA algorithm stands for State Action Reward State Action, which symbolizes the tuple (s, a, r, s′, a′). A Deep Q-Network (or DQN) implements Q-learning within a neural network. The DON can be deployed within a big state space environment where defining a Q-table would be a complex task. In these embodiments, rather than using a Q-table, the DON utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with various embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIG. 1 and FIGS. 3-12 as required to realize a particularly desired embodiment.

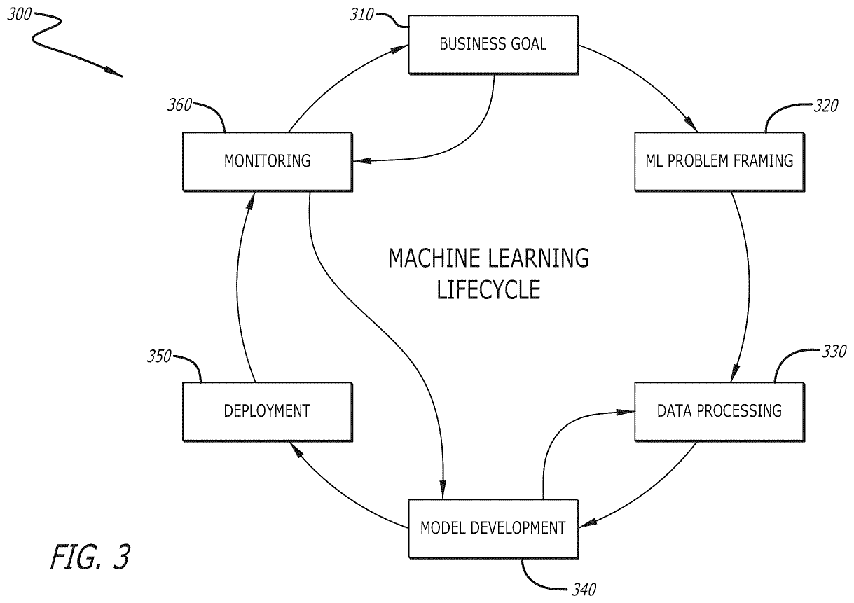

Referring to FIG. 3, a block diagram illustrating a machine learning lifecycle 300 in accordance with various embodiments of the disclosure is shown. While developing machine learning systems, the embodiment depicted in FIG. 3 can provide a framework for structuring the design and maintenance of these machine learning systems. The machine learning lifecycle 300 outlines various stages involved in building, deploying, and improving ML models to solve real-world problems. By following this structured process, businesses and organizations can ensure that their ML projects align with strategic goals, utilize data effectively, and adapt to changing conditions over time. This machine learning lifecycle 300 emphasizes that developing an ML model is not a one-time effort but an iterative process requiring ongoing monitoring and adjustment. A feedback loop inherent in the machine learning lifecycle 300 allows for continual refinement and optimization of the ML models to maintain their accuracy and relevance.

In many embodiments, a first stage of the machine learning lifecycle 300 includes identifying a business goal 310, which sets an overall direction and purpose for an ML project. Identifying the business goal 310 can involve understanding specific problems or opportunities within a business or a project that machine learning can address. A clear business goal 310 ensures that the project remains focused on delivering tangible value, it involves optimizing collaborative efforts in real-time operations, refining decision-making processes for dynamic environments, or autonomously adjusting to changing user queries. Without a well-defined business goal 310, it can be challenging to align subsequent stages of the machine learning lifecycle 300, as the choice of model, data processing methods, and performance metrics can all depend on what the business aims to achieve.

Establishing a proper business goal 310 can also involve engaging with key stakeholders and developers to gather requirements and set success criteria, which can provide a roadmap that outlines what success looks like and helps in framing an ML problem. For example, if the goal is to flatten (or summarize) a hierarchical schema in such a way that information can be queried efficiently to build prompt(s) and construct a query in a hierarchical query language, the project may focus on developing an AI-based query management device that enables flattening of hierarchical schemas into a linear format. Clearly defined business goals not only help guide the project but also provide benchmarks for evaluating the effectiveness of the deployed ML model once the deployed ML model enters production.

Once the business goal 310 is established, various embodiments take a next step involving ML problem framing 320, wherein the business goal 310 is translated into a specific machine learning task. This can involve selecting the appropriate type of ML problem, such as classification, regression, clustering, or recommendation, and defining target variables or outputs. For example, if the business goal 310 is to generate accurate queries for complex hierarchical databases, the problem can be framed as a query management task where the model may simplify schema representation and enhance the semantic context. Proper ML problem framing 320 determines particular data requirements, choice of model, and evaluation metrics.

During the stage of ML problem framing 320, it is also prudent to consider constraints and assumptions that may affect the development of the ML model. The constraints and assumptions may include, for example, data availability, computational resources, ethical considerations, or regulatory compliance. Properly framing the ML problem ensures that the development of the ML model aligns with the needs of the business and that the ML problem is broken down into manageable steps, ultimately increasing the project's chances of success.

Data processing 330 is a stage in many embodiments where raw data is collected, cleaned, and transformed into a format suitable for machine learning. This stage of the machine learning lifecycle 300 can involve gathering data from various sources, removing errors or inconsistencies, handling missing values, and normalizing or scaling features to ensure that the ML model can learn effectively. Feature engineering is often a part of this stage, where new features are derived from the raw data to capture more relevant information and improve model performance.

The quality and preparation of the utilized data can significantly impact the accuracy and reliability of the ML model. Inadequate or poorly processed data can lead to biased or inaccurate predictions, no matter how advanced the ML model is. Hence, data processing 330 can require or at least benefit from careful planning and iterative refinement. Once the data is processed, the data is typically split into training, validation, and test datasets to develop and evaluate the ML model, ensuring that the ML model generalizes well to new, unseen data.

Model development 340 is a stage, in a number of embodiments, where machine learning algorithms are selected, trained, and refined to create an ML model that addresses the framed problem. This stage can involve choosing an appropriate algorithm (e.g., decision trees, neural networks, support vector machines, or the like), setting up the architecture of the ML model, and defining hyperparameters that will guide the training process. The ML model is trained on the processed data to identify patterns and relationships that allow the ML model to make predictions or decisions.

During model development 340, the ML model can be evaluated using the validation dataset to finetune its parameters and improve performance. Techniques such as cross-validation, regularization, and hyperparameter tuning can be utilized to prevent overfitting and ensure the ML model generalizes well. If proper steps are taken, the result is an ML model that, once the ML model meets predefined performance metrics, is ready for deployment in a real-world environment. However, model development 340 often involves several iterations to optimize the ML model for the specific business goal, indicated by an arrow directed back to data processing 330.

In a variety of embodiments, deployment 350 is the stage of the machine learning lifecycle 300 where the developed ML model is integrated into a production environment to perform its intended tasks. This stage may involve setting up necessary infrastructure, such as Application Programming Interfaces (APIs) or cloud-based services, to allow the ML model(s) to process live data and generate predictions. Deployment 350 can transform the ML model from a research tool into a functional component of a business process or product, providing real-time insights, automations, or decisions.

Proper deployment 350 can also include setting up mechanisms for logging, error handling, and user access. Since real-world environments are often dynamic and differ from training conditions, deployment 350 may require continuous adaptation and updates to ensure the ML model(s) operates efficiently. This stage may define the success of the ML model because the ML model's success is not only determined by its performance metrics but also by its ability to provide actionable results that align with the business goal 310.

In various embodiments, monitoring 360 is an ongoing process of tracking the performance and behavior of the ML model after deployment 350. Monitoring 360 involves collecting data on the ML model's predictions, accuracy, latency, and error rates to detect issues such as concept drift, where changes in the underlying data patterns can degrade the accuracy of the ML model. By continuously monitoring 360, teams can identify when the performance of the ML model drops and requires retraining or adjustments to align with evolving data.

Monitoring 360 can also encompass aspects such as user feedback, security, and compliance, ensuring that the ML model remains effective, reliable, and ethical in its application. Monitoring 360 may serve as a feedback loop in the machine learning lifecycle 300, where insights gained from monitoring feedback into the earlier stages of the machine learning lifecycle 300, particularly data processing 330 and model development 340, to refine the ML model(s) as needed. This iterative process allows a machine learning system to adapt and maintain its alignment with the original business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the ML model(s) may not follow this machine learning lifecycle 300 completely. As those skilled in the art will recognize, there are a variety of ways to develop AI products that include various iterative steps that aid in development and refinement of different ML models. The elements depicted in FIG. 3 may also be interchangeable with other elements of FIGS. 1-2 and FIGS. 4-12 as required to realize a particularly desired embodiment.

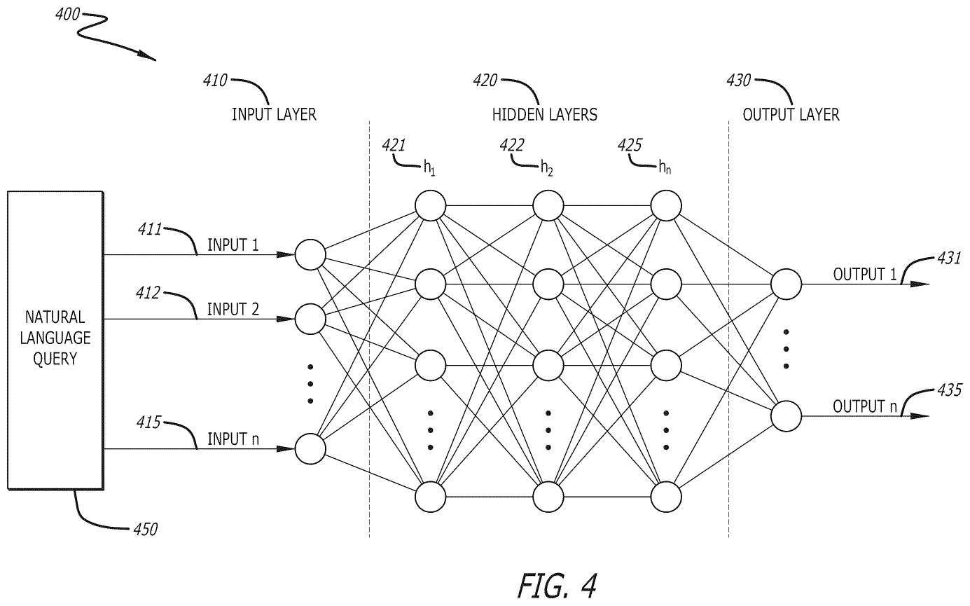

Referring to FIG. 4, a schematic diagram illustrating an example neural network 400 in accordance with various embodiments of the disclosure is shown. The embodiment illustrated in FIG. 4 specifically depicts a feedforward neural network with multiple layers. This type of network includes an input layer 410, one or more hidden layers 420, and an output layer 430. Each layer contains nodes (or neurons) that are interconnected, representing how data flows through the feedforward neural network. The input layer 410 can receive input data 450, which is then processed by the hidden layers 420 through weighted connections and activation functions. These hidden layers 420 can enable the feedforward neural network to learn complex patterns and relationships within the input data 450.

The final output layer 430 produces predictions or classifications of the feedforward neural network based on the processed natural language query. The interconnected nature of the nodes allows the neural network 400 to learn from the input data 450 during training by adjusting weights of connections to minimize prediction errors. This structure is the foundation of deep learning models, as adding more hidden layers 420 can create a deep neural network, capable of tackling highly complex tasks such as image recognition, NLP, and pattern detection in large datasets.

A perceptron or a single artificial neuron is the building block of ANNs and can perform forward propagation of information. For a set of inputs to the perceptron, weights (and biases to shift weights) can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 400 can be initialized randomly or obtained from a pre-trained model. These weight matrices can be multiplied with the input matrix (or output from a previous layer) and subjected to a nonlinear activation function to yield updated representations, which are often referred to as activations or feature maps. A loss function (also known as an objective function or empirical risk) can often be calculated by comparing the output of the neural network 400 and known target value data.

Feedforward networks, such as the neural network 400 depicted in the embodiment of FIG. 4, are often configured as neural networks where information moves in one direction, from the input layer 410 through the hidden layers 420 to the output layer 430, without any cycles or loops. The feedforward networks are primarily utilized for tasks such as classification, regression, and simple pattern recognition, where each input is processed independently of others. In contrast, backpropagation is not a separate type of network but rather a training algorithm commonly utilized in both feedforward and other types of networks such as Recurrent Neural Networks (RNNs).

Backpropagation involves adjusting the weights of the neural network in a reverse direction (from output to input) based on an error between a predicted output and an actual target during training. While feedforward describes the structure and data flow within the neural network, backpropagation is a technique utilized to optimize the model. Feedforward networks are utilized for straightforward tasks where input-output relationships are not sequential or time-dependent. However, for problems involving learning complex patterns over time, such as speech recognition or time-series analysis, neural networks that leverage backpropagation for training such as RNNs or deep feedforward networks with many hidden layers, become necessary to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text into categories such as anomaly detection in the network event data or network event classification. The neural network architecture is also useful in regression problems, such as predicting stock prices or energy consumption, where input features can be processed to output continuous values. However, this is a general example of an AI model, illustrating how a feedforward neural network works. Depending on the problem, other methods and models may be more appropriate. For example, CNNs are often utilized for image processing tasks, while RNNs are suitable for sequential data such as time series data or text. Additionally, simpler models such as linear regression, decision trees, or SVMs may be sufficient if the problem is less complex, or a dataset is relatively small. The embodiment depicted in FIG. 4 is presented as an example ML solution that may be deployed within one or more methods or systems described herein.

In a number of embodiments, the input layer 410 is the first layer in the neural network 400 and serves as the initial point where input data 450 is introduced into the model. Each node (or neuron) in this input layer 410 represents an individual feature or variable from the dataset, allowing the neural network 400 to receive and process various types of data, such as features in the input data 450, pixel values in an image, numerical features in a spreadsheet, or words in a text document. For instance, in image recognition tasks, the input layer 410 can include nodes that correspond to pixel values of the image, providing the neural network 400 with visual information needed to identify objects or patterns. The number of nodes in the input layer 410 directly depends on the number of features present in the dataset. If there are one hundred features in the input data 450, the input layer 410 will typically have one hundred nodes, each conveying one piece of the information to the subsequent layers. In a variety of embodiments, the inputs of the neural network 400 are generally scaled, that is, normalized to have a zero mean and/or a unit standard deviation. Scaling can also be applied to the input of the hidden layers 420, for example, by utilizing batch or layer normalization to improve the stability of the neural network 400.

Unlike the hidden layers 420 and the output layer 430, the input layer 410 typically does not perform any computations or transformations on the data. The primary function of the input layer 410 is often to pass the input data to the next layer in the neural network 400, that is, the first hidden layer 421. However, it is often desired that the data fed into this hidden layer 421 is preprocessed appropriately, such as being normalized or standardized, to ensure that the neural network 400 can learn efficiently. Proper preprocessing, for example, scaling numerical values or encoding categorical variables, can help the neural network 400 process data uniformly, facilitating more stable and faster convergence during training.

The design of the input layer 410 depends on the nature of the problem. For example, in NLP, the input layer 410 may represent words encoded as numerical vectors, while in time series analysis, each node may represent a data point in a sequence. While the input layer 410 itself does not modify the data, the input layer 410 sets the stage for the neural network 400 to extract complex patterns and relationships through the deeper layers. This flexibility in handling various types of input make the neural network 400 a powerful tool for a diverse set of applications.

With respect to the embodiments described herein, the input layer 410 may be configured with a plurality of inputs providing input data 450. For example, the input data may be natural language queries. For example, the model can be configured with a first input 411 configured as a first query, a second input 412 configured as a second user query, while additional inputs can be added related to the number of user queries received. The nth input 415 can be configured in various embodiments to include nth query. However, as those skilled in the art will recognize, additional setups can be configured such that the inputs can be configured to also include different parameters such as previous user queries, corresponding responses, and/or feedback from system administrators.

In more embodiments, the neural network 400 comprises a plurality of hidden layers 420. The embodiment depicted in FIG. 4 comprises a first hidden layer 421, a second hidden layer 422, and an nth hidden layer 425, which are denoted as h₁, h₂, and hₙ, respectively. In additional embodiments, the hidden layers 420 are disposed where the core of the ML model's learning and pattern recognition occurs. In each of the hidden layers 420, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the neural network 400 to capture complex patterns in the data that simple linear models cannot. The intricate web of connections among neurons across layers helps the neural network 400 transform and process input features into representations that become progressively more abstract and useful for making predictions.

The first hidden layer 421, h₁, receives direct input from the input layer 410, transforming the raw input data 450 into an initial set of features. For example, in a network event classification task, the first hidden layer 421 may initiate identifying patterns in basic statistical features such as flow duration, packet size, number of packets, inter-arrival times, or the like; detecting outliers or instances that deviate substantially from the rest of the training data such as unexpected protocol transitions, unusual spikes in the network traffic, unexpected state transitions in communication protocols; or the like. The output of the first hidden layer 421 is then passed to the second hidden layer 422, h₂, which builds upon the features identified by the first hidden layer 421. This deeper hidden layer 422 may start recognizing more complex patterns, such as large packet sizes with short flow durations, frequent transitions between different protocols, repeated bursts of network traffic across multiple time windows, unusual time patterns in the flow of packets, or the like, by combining the lower-level features identified in the previous hidden layer. This can continue until a last, nth hidden layer 425, hₙ, continues this abstraction process, allowing the neural network 400 to recognize even higher-level, more detailed features, such as identifying a combination of multiple protocol transitions over time that indicate a multi-stage attack, for example, Man-in-the-Middle (MitM) attacks, Advanced Persistent Threats (APTs), or the like, or understanding intricate relationships in the input data 450. With respect to the embodiments described herein, the hidden layers 420 may learn one or more patterns of the input data 450 to extract higher-level features from the raw input data 450, thereby improving the ability of the ML model to distinguish between normal network events, critical network events, or anomalous network events.

Each of the hidden layers 420 adds a level of complexity and abstraction to the learning capabilities of the neural network 400. The multi-layer structure can enable the neural network 400 to move from recognizing simple patterns in the first hidden layer 421 to highly complex, abstract concepts in the deeper hidden layers. The number of hidden layers 420 and neurons within them can vary depending on the complexity of the problem. More hidden layers 420 generally allow the neural network 400 to model more intricate functions, making deep neural networks especially effective for tasks such as image recognition, NLP, anomaly detection, and complex predictive modeling. However, adding more layers also increases the computational demand and the risk of overfitting, highlighting the need to carefully design and tune these hidden layers 420 for optimal performance.

In further embodiments, the output layer 430 is often the final layer in the neural network 400 and is responsible for producing predictions or classifications of the neural network 400 based on the information processed through the previous hidden layers 420. Each neuron in the output layer 430 can represent a specific outcome or category that the ML model can predict. In the embodiment depicted in FIG. 4, the outputs are labeled as “output 1” 431 to “output n” 435, indicating that the neural network 400 can be designed to have a varying number of outputs depending on the nature of the problem being solved. For example, in a binary classification, there would typically be a single output neuron that provides a probability score for one of the two classes/outcomes. In contrast, for multi-class classification, the output layer 430 would contain multiple neurons, each corresponding to a different class.

The number of neurons in the output layer 430 can also be designed specifically for other types of tasks, such as regression, where the ML model can predict continuous values. In such cases, the output layer 430 may contain a single neuron representing a numerical prediction, such as a price of a house or a temperature forecast, etc. Alternatively, in complex applications such as multi-label classification (where each input can belong to multiple classes simultaneously), the output layer 430 could have multiple neurons, each representing a different class, with each neuron outputting a probability of the input belonging to that specific class.

The activation function utilized in the output layer 430 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 430 allows the neural network 400 to be applied to a wide variety of tasks, from simple binary decisions to complex multi-output predictions, making them a versatile tool in artificial intelligence and machine learning.

Although a specific embodiment for an example neural network 400 suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. The elements depicted in FIG. 4 may also be interchangeable with other elements of FIGS. 1-3 and FIGS. 5-12 as required to realize a particularly desired embodiment.

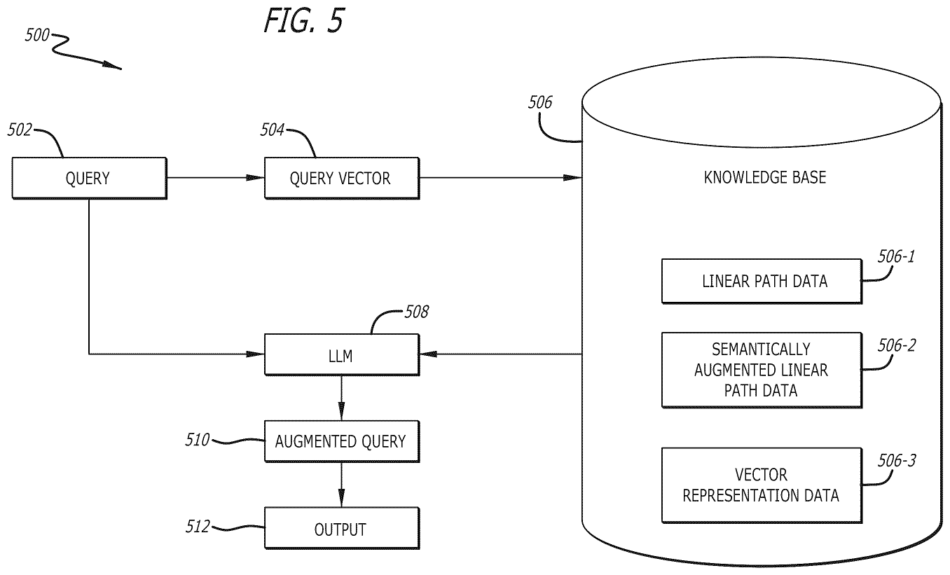

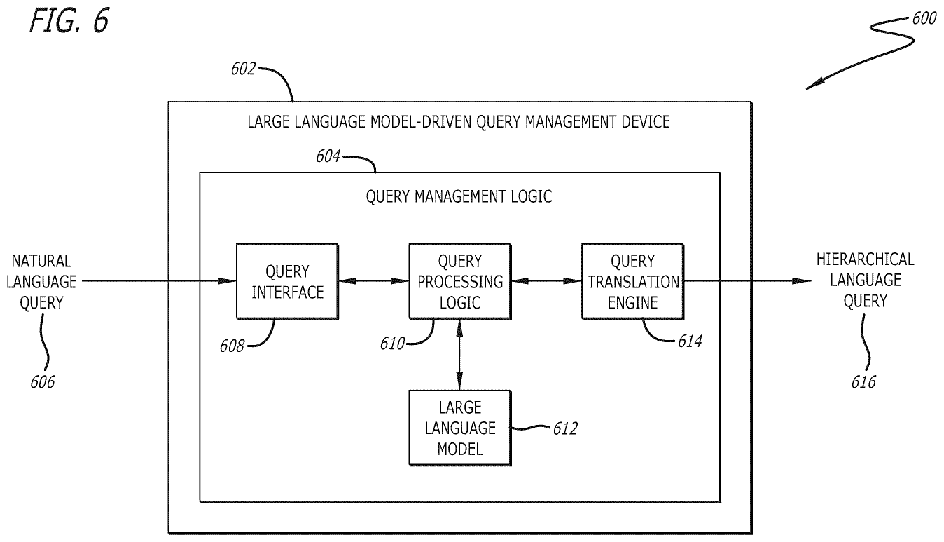

Referring to FIG. 5, a schematic diagram illustrating a system architecture 500 for AI-driven querying of hierarchical data in accordance with various embodiments of the disclosure is shown. AI-driven querying may refer to a method for converting a query in a natural language to an augmented query in a hierarchical language. In many embodiments, a natural language query may refer to a user input, a question, or a prompt provided in a human-readable, free-form language. The natural language query may be ambiguous, unstructured, or semantically rich. The natural language query may be interpretable by an AI-driven device (e.g., an “LLM-driven query management device 602” shown in FIG. 6) or a language processing engine to extract user intent and retrieve or generate relevant structured output. In a variety of embodiments, a hierarchical language query may refer to a query over data organized in a hierarchical or tree-structured format. Unlike flat data models, for example, but not limited to, relational tables, hierarchical data models may include nested parent-child relationships between nodes or elements, with multiple levels of depth. In a number of embodiments, the hierarchical language may traverse, filter, and/or extract information from structured hierarchies by specifying a path through nested data.

In the embodiment depicted in FIG. 5, the AI-driven device may receive a query 502 in natural language. The query 502 may interchangeably be referred to as “natural language query 502”. In an example, the query 502 may be received from a user. In more examples, the query 502 may be received from an external system. In more embodiments, the query 502 may be received by the AI-driven device via, but not limited to, a graphical user interface (GUI), an application programming interface (API), a command-line interface (CLI), a chatbot interface, or any other mechanism that allows the user or the external system to submit the query 502 in the natural language. In further embodiments, the query 502 may be received as a text input, a speech input (converted to text), or in any other interpretable form.

In still more embodiments, the query 502 may represent a request for information or an instruction expressed in plain language related to a hierarchical data model. By allowing the query 502 to be submitted in natural language form, the AI-driven device may enable users to interact with complex hierarchical data without requiring knowledge of the underlying schema structure or formal query syntax, thereby improving usability and accessibility across technical and non-technical user groups.

In still further embodiments, the AI-driven device may convert the query 502 into a query vector 504. The query vector 504 may refer to a semantic embedding that represents the meaning of the natural language input in a high-dimensional space suitable for similarity-based comparison against pre-encoded hierarchical path data. In some more embodiments, the AI-driven device may utilize a pretrained or fine-tuned language model, such as, but not limited to, a transformer-based embedding model, to process the query 502 and convert the query 502 into the query vector 504. In yet more embodiments, the AI-driven device may utilize the generated query vector 504 to query a knowledge base 506 (for example, an embedding vector database) to identify one or more semantically relevant matches from a set of vector representations corresponding to semantically augmented hierarchical paths.

In still yet more embodiments, the knowledge base 506 may be configured to store semantically enriched representations of hierarchical data model paths. The hierarchical data model may include a plurality of nodes. In one or more embodiments, a node in the hierarchical data model may refer to a discrete structural element that may represent a data field, attribute, container, list, operational state, or the like. In many further embodiments, the plurality of nodes may include root nodes, intermediate nodes, and leaf nodes. The root nodes may refer to the topmost element in the hierarchy. The intermediate nodes may refer to elements that have both parent and child nodes. The leaf nodes may refer to terminal elements that do not contain child nodes and represent actual data values or configuration parameters.

In many additional embodiments, each node may include metadata such as, but not limited to, a name or an identifier, a data type, operational attributes, constraints or flags, descriptive annotations used for documentation or user interpretation, or the like. Hierarchical data models may be used in network configuration, systems modeling, structured data exchange protocols, or the like. For example, YANG models may be used in network device configurations, XML Schema (XSD) may define valid XML structures, JSON Schema may organize nested JSON data, and Protobuf may define structured data for serialization.

In still yet further embodiments, the AI-driven device may flatten the hierarchical data model into a plurality of linear paths. A sequence of node identifiers may be utilized to represent a complete traversal from the root node to a target leaf node. The linear paths may be semantically enriched and transformed into vector embeddings to enable natural language interaction and structured query generation. In still yet additional embodiments, the knowledge base 506 may include one or more data layers or components, including but not limited to, linear path data 506-1, semantically augmented linear path data 506-2, vector representation data 506-3, or the like.

In several embodiments, the linear path data 506-1 may include a plurality of linearized representations of paths generated from the hierarchical data model. Each linear path may represent a traversal from the root node to the leaf node, preserving the full hierarchical context as a single flattened sequence.

In several more embodiments, the linear path(s) may be enriched or augmented with semantic data derived from the hierarchical data model to generate the semantically augmented linear path data 506-2. In numerous embodiments, the semantic augmentation may include, but is not limited to, node-level descriptions, metadata (for example, data types, operational flags), structural relationships (for example, parent-child or sibling context), container classifications, or the like.

In numerous additional embodiments, the vector representation data 506-3 may include embedding vectors generated from the semantically augmented linear path data 506-2. Each vector representation may encode the meaning and context of a specific linear path in a high-dimensional vector space, enabling efficient similarity search based on semantic proximity. By organizing and storing both structural and semantic representations of hierarchical data in vectorized form, the knowledge base 506 may enable accurate and scalable retrieval of information relevant to user intent, even when the query 502 may be ambiguous, imprecise, or expressed using domain-specific language.

In further additional embodiments, the AI-driven device may perform a similarity search for the query vector 504 in the knowledge base 506. The search may be conducted using cosine similarity, dot product, or other distance metrics, depending on the embedding model and database implementation. While vector-based similarity search is employed in various embodiments to retrieve information from the knowledge base 506, in one or more embodiments, other search techniques may be utilized alternatively or in combination, depending on implementation constraints, performance requirements, or data structure. In response to the search (for example, similarity search, but not limited to the like), the knowledge base 506 may retrieve one or more vector representations from the vector representation data 506-3 based on the query vector 504. In an example, the one or more vector representations retrieved from the vector representation data 506-3 based on the query vector 504 may correspond to K-nearest neighbors of the query vector 504. Based on the retrieved one or more vector representations, the AI-driven device may identify a linear path from the linear path data 506-1 and a semantically augmented linear path from the semantically augmented linear path data 506-2, corresponding to the natural language query 502.

The retrieved information, for example, the linear path, the semantically augmented linear path, or both may be provided to the LLM 508. In many embodiments, the LLM 508 may be configured to generate an augmented query 510 in a structured or hierarchical query language based on at least one of, the natural language query 502, the semantically augmented linear paths, or the linear paths retrieved from the knowledge base 506.

In a variety of embodiments, the LLM 508 may be implemented using a pretrained or fine-tuned generative language model capable of understanding natural language inputs and generating machine-readable outputs. In the embodiment shown in FIG. 5, the LLM 508 may receive the natural language query 502 and the retrieved information from the knowledge base 506. In a number of embodiments, the LLM 508 may interpret user intent, identify semantic context, map the user intent to one or more structured query expressions in the hierarchical language. By leveraging the generative capabilities of the LLM 508, the AI-driven device can automatically translate ambiguous or unstructured natural language queries (for example, query 502) into precise, executable queries (for example, augmented query 510) that align with the structure and semantics of the underlying hierarchical data model. The structure and syntax of the augmented query 510 may be governed by the schema associated with the hierarchical data model, ensuring that the augmented query 510 can be successfully executed against the target system or data store.

In more embodiments, the augmented query 510 may include a fully qualified path expression that reflects the structure of the relevant portion of the hierarchical data model, variable substitutions (for example, template names or filter values) derived from the natural language query 502, query modifiers, such as attribute filters, conditions, or wildcards, which narrow or refine the result set, schema-compliant formatting, ensuring alignment with configuration, operational, or informational attributes defined in the data model, or the like. In additional embodiments, the augmented query 510 may be fully structured, executable, and ready for processing by systems or data stores that consume the hierarchical data model (for example, YANG-based network configuration platforms). Therefore, generation of the augmented query 510 by the LLM 508 may allow users to access complex structured data using intuitive, human-readable expressions, without needing to understand or interact directly with the underlying schema or query language.

In further embodiments, the augmented query 510 may be processed, presented, or executed by the AI-driven device as output 512. For example, the AI-driven device may submit (for example, output 512) the augmented query 510 to a backend system or database that supports the corresponding hierarchical query language (for example, a YANG-enabled network configuration platform), and retrieve the corresponding data or result set. The AI-driven device may convert the query results into a human-readable format, such as a structured list, table, tree view, or configuration snippet, suitable for presentation in a GUI, CLI, API response, or the like. In another example, the AI-driven device may display (for example, output 512) the augmented query 510 to the user for review, allowing manual confirmation, editing, or validation prior to execution. The user may be presented with the generated augmented query 510 and may provide additional instructions or corrections to narrow, expand, or adjust the query. In one or more embodiments, the LLM 508 may update the augmented query 510 incrementally in response to the feedback. In another example, the AI-driven device may transmit the results of the augmented query 510 to another module, system, or user endpoint, such as a monitoring dashboard, network management console, orchestration engine, automation script, or the like.

In still more embodiments, the AI-driven device may handle error(s) such as, but not limited to, detecting and reporting invalid or unsupported query syntax. In such embodiments, the LLM 508 may be prompted to re-generate the augmented query 510 if the initial execution fails. In one or more embodiments, logs or trace data may be stored in a memory or database associated with the AI-driven device, capturing the original natural language query (for example, query 502), the generated augmented query 510, the retrieved semantic information from the knowledge base 506, and the final output 512. This may provide traceability for audits, debugging, or iterative improvement of the language model.

Although a specific embodiment for an AI-driven system architecture 500 suitable for carrying out the various steps, processes, methods, and operations described herein is discussed with respect to FIG. 5, any of a variety of systems and/or processes may be utilized in accordance with embodiments of the disclosure. For example, the AI-driven device may be utilized for Internet of Things (IoT) device orchestration, wherein a large-scale deployment of heterogeneous devices, such as sensors, actuators, edge controllers, or the like, may be described using a hierarchical configuration schema (for example, JSON Schema or a custom tree-structured metadata model). In such embodiments, the hierarchical data model may define nested device relationships, location-based groupings, configurable parameters, conditional behaviors, or the like based on environmental states. The elements depicted in FIG. 5 may also be interchangeable with other elements of FIGS. 1-4 and FIGS. 6-12 as required to realize a particularly desired embodiment.

Referring to FIG. 6, a block diagram 600 illustrating an LLM-driven query management device 602 in accordance with various embodiments of the disclosure is shown. For example, the LLM-driven query management device 602 (interchangeably referred to as the “LLM-driven device 602”) may correspond to the AI-driven device described in FIG. 5.

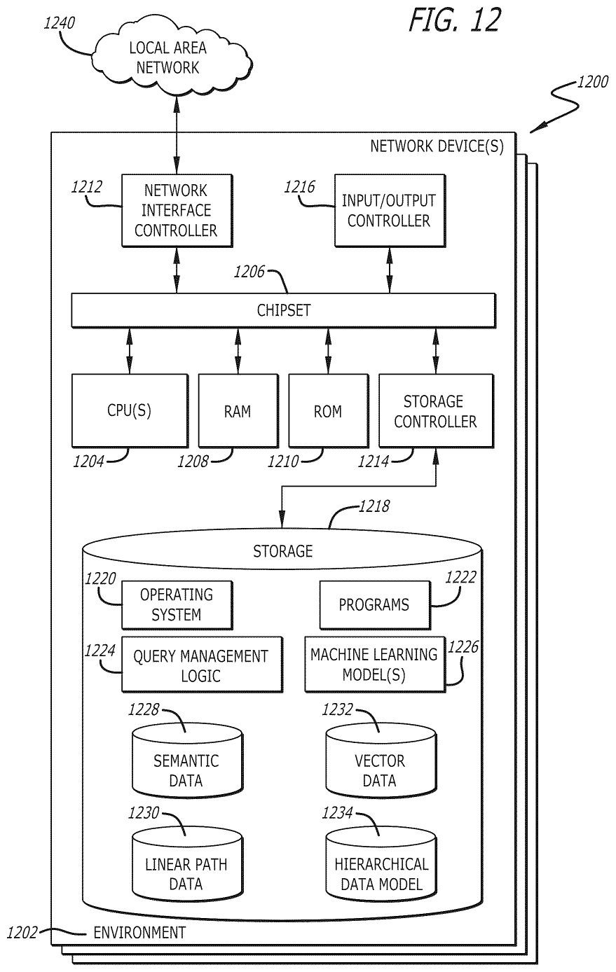

In a variety of embodiments, the LLM-driven device 602 may be an AI-enabled system or hardware/software module that leverages an LLM to interpret, process, and translate natural language inputs into structured, executable queries that conform to a hierarchical data schema. In a number of embodiments, the LLM-driven device 602 may be implemented as a standalone server, an edge computing device, a cloud-hosted application, or part of a distributed AI infrastructure. In more embodiments, the LLM-driven device 602 may include hardware components such as one or more processors, memory units, and network interfaces to enable communication with user input systems and a backend data store, which is explained in detail with reference to FIG. 12. In additional embodiments, the LLM-driven device 602 may be configured to operate in real-time, supporting high-speed interpretation and generation of hierarchical queries across a variety of use cases, including, but not limited to, data configuration, policy management, analytics, natural language interfaces for technical systems, or the like. In this way, the LLM-driven device 602 may improve the usability, accessibility, and precision of query construction in environments governed by complex hierarchical data models. This may enable users to interact with such models using intuitive natural language inputs and receive syntactically valid, machine-executable output. In several embodiments, the LLM-driven device 602 may be configured to receive a natural language query 606 and generate a corresponding hierarchical language query 616. For example, the LLM-driven device 602 may analyze the semantic context of the natural language query 606, retrieve or synthesize relevant structured knowledge, and translate user intent into an augmented query (e.g., the hierarchical language query 616) in the hierarchical query language. In one or more embodiments, the natural language query 606 and the hierarchical language query 616 of FIG. 6 may be similar to the respective query 502 and augmented query 510 of FIG. 5.

In the embodiment shown in FIG. 6, the LLM-driven device 602 may include a query management logic 604. The query management logic 604 may be configured to manage queries received by the LLM-driven device 602. The query management logic 604 may include various hardware and/or software deployments and can be configured in various ways. In further embodiments, the query management logic 604 may include several interconnected components that work collaboratively to analyze, interpret, and transform natural language into structured output. In a variety of embodiments, the query management logic 604 may include a query interface 608, a query processing engine 610, an LLM 612, and a query translation engine 614. Through the operation of the query management logic 604, the LLM-driven device 602 may seamlessly bridge the gap between free-form user queries and the structured query formats required to interact with complex data models, such as those defined by YANG, XML Schema, JSON Schema, or the like.

In still more embodiments, the query interface 608 may be configured to receive the natural language query 606 as an input. In an example, the query interface 608 may be configured to receive the natural language query 606 from a user. In more example, the query interface 608 may be configured to receive the natural language query 606 from an external system or service. In an example, the natural language query 606 may be generated programmatically. In still further embodiments, the query interface 608 may support the input through a variety of channels and formats, including but not limited to GUIs, APIs, CLIs, voice input systems that convert spoken language into text, or the like. The natural language query 606 received through the query interface 608 may be free-form, unstructured, or semi-structured, and may include instructions, questions, or requests related to hierarchical data. In still additional embodiments, the query interface 608 may provide feedback to the user or the external system that may include, but not limited to, reformulations of ambiguous queries, query refinement, clarification prompts, or the like.

Once the natural language query 606 is received and optionally pre-processed (for example, for language normalization, spell correction, user authentication, session management, etc.), the query interface 608 may pass the natural language query 606 to the query processing engine 610 for further handling. The query processing engine 610 may be configured to interpret the natural language query 606 received from the query interface 608 to extract semantic context, user intent, relevant structural context, or the like. In some more embodiments, the query processing engine 610 may communicate with the LLM 612 to analyze the natural language query 606. The query processing engine 610 may convert the natural language query 606 into a query vector (for example, the query vector 504). Further, the query processing engine 610 may utilize the query vector to search a knowledge base (for example, the knowledge base 506). For example, the knowledge base may store a set of vector representations. In response to the search, the query processing engine 610 may retrieve one or more vector representations from the set of vector representations (for example, from the vector representation data 506-3) based on the query vector. For example, the query processing engine 610 may identify the k most similar vector representations to the query vector using a distance metric (e.g., cosine similarity or Euclidean distance). These k nearest neighbors may correspond to data items most relevant to the natural language query 606. Based on the retrieved one or more vector representations, the query processing engine 610 may identify at least one linear path of a plurality of linear paths (for example, from the linear path data 506-1) and at least one augmented linear path of a plurality of augmented linear paths (for example, from the semantically augmented linear path data 506-2) associated with a hierarchical data model. In an example, the at least one augmented linear path may interchangeably be referred to as the at least one semantically augmented linear path and the plurality of augmented linear paths may interchangeably be referred to as augmented plurality of linear paths or augmented plurality of linear paths

In yet more embodiments, the query processing engine 610 may perform one or more operations associated with the hierarchical data model for generation of the set of vector representations. For example, the query processing engine 610 may be configured to flatten the hierarchical data model into the plurality of linear paths. In still yet more embodiments, the query processing engine 610 may be configured to recursively traverse the hierarchical data model to flatten the hierarchical data model into the plurality of linear paths. In many further embodiments, the query processing engine 610 may be configured to augment the plurality of linear paths with semantic data. The semantic data may be derived from the hierarchical data model. In many additional embodiments, the semantic data may include, but is not limited to, node descriptions, node metadata, or hierarchical node positions, of a plurality of nodes of the hierarchical data model. The node metadata may include, but is not limited to, node types, data types, operational attributes, or configuration flags, of the plurality of nodes. In still yet further embodiments, the query processing engine 610 may be configured to encode one or more augmented linear paths of the augmented plurality of linear paths into the set of vector representations. The set of vector representations may be stored in the knowledge base (for example, knowledge base 506). Thus, when the natural language query 606 is received by the query processing engine 610 via the query interface 608, the query processing engine 610 is enabled to retrieve the relevant information from the knowledge base.

In still yet additional embodiments, the query translation engine 614 may communicate with the LLM 612 to generate the hierarchical language query 616. The hierarchical language query 616 may be generated, via the LLM 612, based on the retrieved information from the knowledge base, such as the linear path, the semantically augmented linear path, or both, and the natural language query 606. For example, the hierarchical language query 616 may be generated by incorporating terms, entities, or relationships identified within the linear path, the semantically augmented linear path, or both into a structured query format. The LLM 612 may utilize contextual information, such as node position, metadata attributes, and parent-child relationships within the linear path, the semantically augmented linear path, or both, to construct a query that reflects both an intent of the user and underlying data structure. In several embodiments, the hierarchical language query 616 may be output (for example, as a fully executable query returned directly to the user) or submitted to a backend system, orchestration engine, or data store for processing.

In several more embodiments, the query translation engine 614 may be configured to validate the generated hierarchical language query 616 against a schema definition associated with the hierarchical data model. The validation may include checking for structural consistency, allowed node transitions, supported operators, data type compatibility, or the like. If the generated hierarchical language query 616 is determined as invalid or incomplete, the query translation engine 614 may prompt the LLM 612 with updated context or correction prompts.

In numerous embodiments, the hierarchical language query 616 may be presented to the user or the external system and prompted to confirm, refine, or clarify specific parts of the hierarchical language query 616 prior to submission for execution. This feedback loop may be used to disambiguate user intent, for example, when the original natural language query 606 includes vague or overloaded terms.

Although a specific embodiment for an LLM-driven query management device suitable for carrying out the various steps, processes, methods, and operations described herein is discussed with respect to FIG. 5, any of a variety of systems and/or processes may be utilized in accordance with embodiments of the disclosure. For example, the LLM-driven device 602 may generate the augmented query in multiple languages such as, but not limited to, XPath, jq, XQuery, JSONPath, SPARQL (for RDF data), GraphQL, or proprietary DSLs, based on the specific schema or data platform in use. The elements depicted in FIG. 5 may also be interchangeable with other elements of FIGS. 1-5 and FIGS. 7-12 as required to realize a particularly desired embodiment.

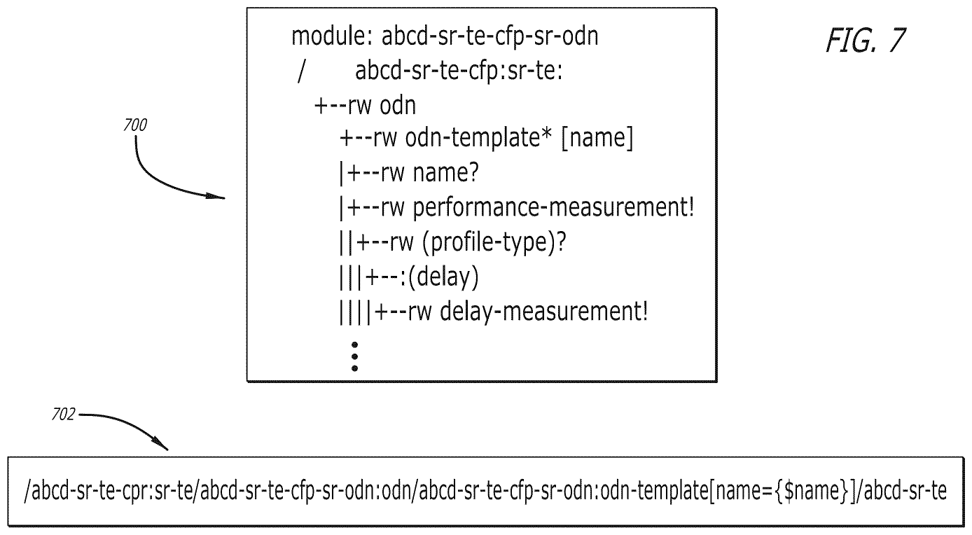

Referring to FIG. 7, a diagram illustrating an example hierarchical data model 700 and a corresponding linear path 702 in accordance with various embodiments of the disclosure is shown. In the example depicted in FIG. 7, the hierarchical data model 700 is defined within a module labeled “abcd-sr-the-cfp-sr-odn”, representing a segment-routing traffic engineering (SR-TE) configuration for on-demand next-hop (ODN) templates. The hierarchical structure includes nested nodes under the container odn-template, which is defined as a list keyed by a name field. Within each template, various configuration sub-nodes are defined, including performance-measurement, and further nested under that, a specific delay profile setting called delay-measurement. This structure may be representative of hierarchical schema models (for example, YANG or XML Schema), in which complex configurations may be represented through recursive parent-child relationships. Each node may include operational annotations (for example, rw for read-write), type constraints, optional grouping information (for example, profile-type, (delay)), or the like.

As discussed herein, an LLM-driven query management device (for example, LLM-driven device 602) may be configured to flatten the hierarchical data model 700 into a plurality of linear paths such as the linear path 702 shown in FIG. 7. The corresponding linear path 702 illustrates the flattened, fully qualified path that uniquely identifies the delay-measurement node in the hierarchy, using a consistent path notation. The linear path 702 may capture the complete traversal from a root node through all intermediate nodes, while retaining identifiers, list keys, and nested relationships. In many embodiments, such paths may be automatically generated by the LLM-driven device via recursive traversal and semantic augmentation, without human intervention. In a variety of embodiments, the linear path 702 may be encoded as strings, augmented with semantic metadata, and stored as part of a vectorized knowledge base (for example, knowledge base 506) for retrieval-augmented query generation. The structure shown in FIG. 7 provides a concrete example of how the LLM-driven device converts hierarchical models into forms usable by language models and vector search engines.

In several embodiments, the flattening of the hierarchical data model 700 into the plurality of linear paths (e.g., the linear path 702 as shown in FIG. 7) may involve data transformation implemented by a specifically configured computing device (e.g., the LLM-driven device 602). In an example, the computing device may employ a recursive parsing algorithm executed by a processor to systematically traverse nested container and list elements within the hierarchical data model 700, extracting fully qualified node identifiers, key expressions (e.g., [name={$name}]), and annotated types. These operations may be performed in a deterministic manner, utilizing memory structures such as stacks or trees to maintain traversal state, and generate the linear paths as structured strings with semantic encoding.

In more embodiments, the plurality of linear paths may be semantically augmented with node-specific metadata, such as data type, node name, access permissions (e.g., read-write), node position, inheritance context, or the like, resulting in semantically augmented linear paths. These augmented linear paths may be stored in vectorized form (e.g., embeddings vector representations, or the like) in a hardware-based knowledge base (e.g., an embedding vector database), which supports accelerated k-nearest neighbor (k-NN) search using processors, providing improved response latency and relevance for natural language query resolution. Accordingly, the described computing device (e.g., the LLM-driven device 602) improves the functioning of the computer itself by enabling the computing device to interpret, store, and retrieve semantically complex hierarchical configurations in a flattened format suitable for machine learning-based reasoning and inference.

Although a specific embodiment for a hierarchical data model 700 and linear path 702 is discussed with respect to FIG. 7, it will be understood that any of a variety of hierarchical schema structures and formatting styles may be utilized in accordance with embodiments of the present disclosure. For example, while FIG. 7 shows a YANG-based network configuration model being flattened into a linear path representation, similar techniques may be applied to hierarchical structures defined using JSON Schema, XML Schema, Protocol Buffers (Protobuf), or custom domain-specific schemas used in areas such as IoT deployments, enterprise access policies, healthcare ontologies, or cloud orchestration templates. The elements depicted in FIG. 7 may also be interchangeable or combinable with elements shown in FIGS. 1-6 and FIGS. 8-12, depending on the desired implementation or target system integration.

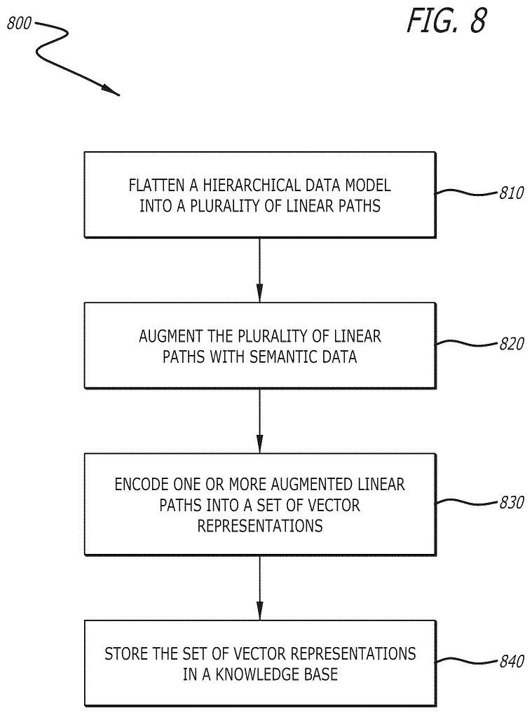

Referring to FIG. 8, a flowchart depicting a process 800 for summarizing a hierarchical data model in accordance with various embodiments of the disclosure is shown. In many embodiments, the process 800 may be implemented in an LLM-driven query management device, for example, the LLM-driven device 602 of FIG. 6.

In a variety of embodiments, the process 800 may flatten a hierarchical data model (for example, the hierarchical data model 700) into a plurality of linear paths (block 810). The hierarchical data model may include a plurality of nodes. The plurality of nodes may include at least a root node and a terminal node (for example, a leaf node). The process 800 may recursively traverse the hierarchical data model to flatten the hierarchical data model into the plurality of linear paths. For example, a linear path of the plurality of linear paths may represent a unique traversal from the root node to the terminal node of the hierarchical data model. For example, flattening the hierarchical data model may include recursively traversing the hierarchical data model from each root node down to all reachable leaf nodes. Each unique traversal may define a fully qualified path, which includes intermediate node names and structural relationships, representing the specific route through which a data field or configuration parameter may be accessed. For example, each path may be defined as a string or sequence of identifiers describing the complete route from the top-level node to a specific terminal node.

In a number of embodiments, the process 800 may augment the plurality of linear paths with semantic data (block 820). As described herein, each linear path may represent a unique traversal from a root node to a terminal node within the hierarchical data model. While the linear path captures structural information, semantic augmentation adds contextual meaning, enabling alignment with natural language queries and enhancing the ability of the LLM-driven query management device to disambiguate similarly structured nodes located in different parts of the hierarchy data model. In more embodiments, to augment the plurality of linear paths with the semantic data, the process 800 may derive the semantic data from the hierarchical data model. In an example, the semantic data may include at least one of node descriptions (for example, human-readable explanations or documentation strings associated with schema nodes), node metadata such as node types (for example, container, list, leaf, choice), data types (for example, string, Boolean, uint32), operational attributes (for example, read-only, configurable), and configuration flags, of the plurality of nodes.

In still more embodiments, the process 800 may encode one or more augmented linear paths into a set of vector representations (block 830). For example, the process 800 may encode one or more augmented linear paths of the augmented plurality of linear paths into the set of vector representations. In an example, the encoding may be performed using a pretrained or fine-tuned language model that supports sentence or sequence embedding. For example, each vector may capture semantic relationships, such that paths with similar meanings (for example, “latency threshold” and “delay setting”) may be mapped to nearby points in the embedding space. This enables the LLM-driven query management device to retrieve the set of vector representations via search (for example, similarity search) later in time.

In still further embodiments, the process 800 may store the set of vector representations in a knowledge base (block 840). In an example, the knowledge base may correspond to an embedding vector database. In one or more embodiments, the process 800 may index the set of vector representations and store the indexed set of vector representations in the knowledge base as vector representation data (for example, the vector representation data 506-3).

Although a specific embodiment for summarizing a hierarchical data model suitable for carrying out the various steps, processes, methods, and operations described herein is discussed with respect to FIG. 8, any of a variety of systems and/or processes may be utilized in accordance with embodiments of the disclosure. For example, although it is described that the process 800 is implemented in an LLM-driven query management device, in numerous embodiments, the process 800 may be implemented in any AI-driven device, which is not limited to LLM-based implementation. Additionally, the elements depicted in FIG. 8 may also be interchangeable with other elements of FIGS. 1-7 and FIGS. 9-12 as required to realize a particularly desired embodiment.

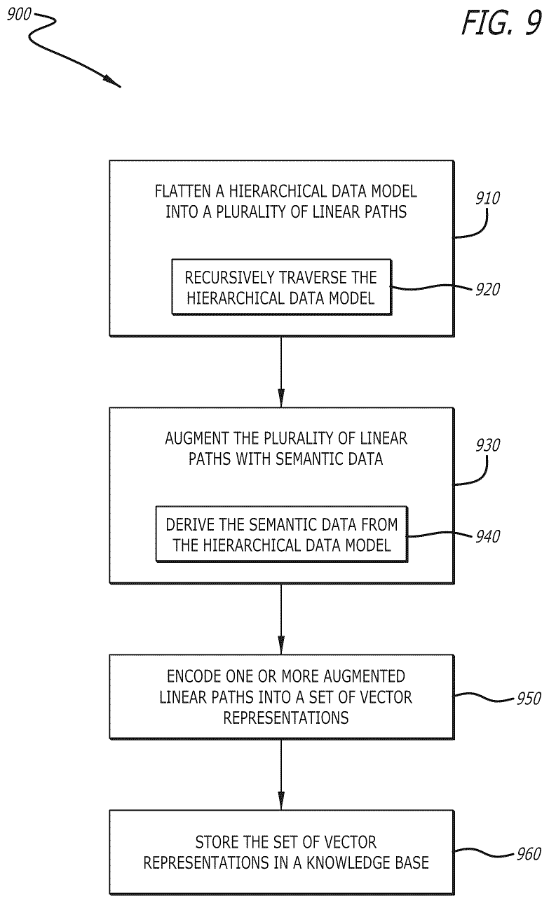

Referring to FIG. 9, a flowchart depicting a more-detailed process 900 for summarizing a hierarchical data model in accordance with various embodiments of the disclosure is shown. In many embodiments, the process 900 may be implemented in an AI-driven query management device, for example, the LLM-driven device 602.

In a number of embodiments, the process 900 may flatten the hierarchical data model into a plurality of linear paths (block 910). The hierarchical data model may include a plurality of nodes. The plurality of nodes may include at least a root node and a terminal node (for example, a leaf node). In a variety of embodiments, to flatten the hierarchical data model into the plurality of linear paths, the process 900 may recursively traverse the hierarchical data model (block 920). For example, a linear path of the plurality of linear paths may represent a unique traversal from the root node to the terminal node of the hierarchical data model. In an example, the hierarchical data model may be recursively traversed to identify and record all possible root-to-leaf paths within the hierarchical data model, each of which may be later transformed into a unique linear path representation. For example, the recursive traversal may begin at a root node of the hierarchical data model and proceed depth-first, visiting each child node and exploring all possible branches down to each terminal or leaf node. At each traversal step, the process 900 may build and record the path by concatenating the identifiers (names or keys) of the nodes visited. In an example, when a leaf node is reached, the completed traversal from the root node to the leaf node may be stored as a fully qualified linear path. In this way, the process 900 may operate on arbitrarily deep or complex schema hierarchies without requiring prior knowledge of their structure.

In additional embodiments, the process 900 may augment the plurality of linear paths with semantic data (block 930). As described herein, each linear path may represent a unique traversal from a root node to a terminal node within the hierarchical data model. While the linear path captures structural information, semantic augmentation adds contextual meaning, enabling alignment with natural language queries and enhancing the ability of the AI-driven query management device to disambiguate similarly structured nodes located in different parts of the hierarchy data model. In one or more embodiments, to augment the plurality of linear paths with the semantic data, the process 900 may derive the semantic data from the hierarchical data model (block 940). In an example, the semantic data may include at least one of node descriptions, node metadata such as node types, data types, operational attributes, and configuration flags, of the plurality of nodes. For example, the process 900 may attach the semantic data to each corresponding linear path, resulting in a set of semantically augmented linear path records. The semantically augmented linear path records may be stored as structured documents (for example, JSON, XML, or key-value maps) and may be subsequently used to generate vector embeddings or to assist in query generation.

In still additional embodiments, the process 900 may encode one or more augmented linear paths into a set of vector representations (block 950). For example, the process 900 may encode one or more augmented linear paths of the augmented plurality of linear paths into the set of vector representations. In an example, the encoding may be performed using a pretrained or fine-tuned language model that supports sentence or sequence embedding. For example, each vector may capture semantic relationships, such that paths with similar meanings (for example, “latency threshold” and “delay setting”) may be mapped to nearby points in the embedding space. This enables the LLM-driven query management device to retrieve the set of vector representations via search (for example, similarity search) later in time.

In still further embodiments, the process 900 may store the set of vector representations in a knowledge base (block 960). In an example, the knowledge base may correspond to an embedding vector database. In one or more embodiments, the process 900 may index the set of vector representations and store the indexed set of vector representations in the knowledge base as vector representation data (for example, the vector representation data 506-3).

Although a specific embodiment for a more-detailed process 900 for summarizing a hierarchical data model suitable for carrying out the various steps, processes, methods, and operations described herein is discussed with respect to FIG. 9, any of a variety of systems and/or processes may be utilized in accordance with embodiments of the disclosure. For example, the process 900 may be adapted for use in enterprise knowledge systems, intent-based automation platforms, or multi-domain data analytics engines, where user queries in natural language are to be mapped to structured schemas governing data sources such as IoT deployments, cloud configurations, access control policies, or enterprise service catalogs. The elements depicted in FIG. 9 may also be interchangeable with other elements of FIGS. 1-8 and FIGS. 10-12 as required to realize a particularly desired embodiment.

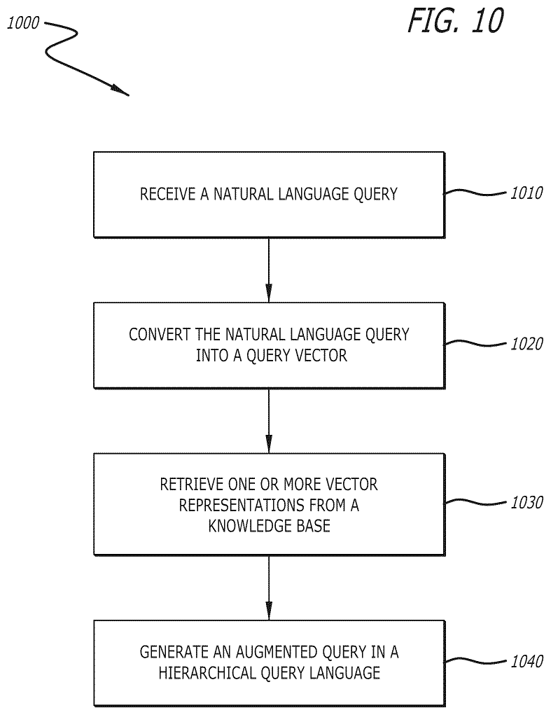

Referring to FIG. 10, a flowchart depicting a process 1000 for generating an augmented query in a hierarchical query language from a natural language query (for example, LLM-driven device 602) in accordance with various embodiments of the disclosure is shown. In many embodiments, the process 1000 may receive a natural language query (for example, natural language query 502 or 606) (block 1010). The natural language query may be received in free-form, human-readable language, such as any supported language. In a variety of embodiments, the query may be received via a query interface (for example, query interface 608).

In a number of embodiments, the process 1000 may convert the natural language query into a query vector (for example, query vector 504) (block 1020). The natural language query may be converted by a query processing engine (for example, the query processing engine 610) for use in performing a search in a knowledge base (for example, knowledge base 506). In an example, the query vector may correspond to an embedding vector. In one or more embodiments, the process 1000 may utilize a pre-trained or fine-tuned embedding model (for example, a transformer-based language model or a sentence encoder) to generate the query vector from the natural language query. For example, if a user inputs a natural language query such as “show templates with delay measurement enabled,” the process 1000 may convert this natural language query into a query vector that captures concepts such as “template,” “delay,” and “enabled.” In further embodiments, the process 1000 may use domain-specific data such as annotated YANG models, or domain glossaries to incorporate additional context (for example, user role, historical queries, or device-specific constraints) into the query vector.

In more embodiments, the process 1000 may retrieve one or more vector representations from the knowledge base (block 1030). The one or more vector representations may correspond to a set of semantically augmented linear paths of a hierarchical data model (for example, hierarchical data model 700). In additional embodiments, the process 1000 may perform a similarity search in the knowledge base between the query vector and the stored vector representation data (for example, vector representation data 506-3). The knowledge base may include a vector representation constructed from flattened and semantically augmented linear paths of the hierarchical data model. Each vector representation may be associated with a specific linear path associated with the hierarchical data model. In further embodiments, the process 1000 may identify one or more linear paths of a plurality of linear paths, one or more semantically augmented linear paths of a plurality of semantically augmented linear paths, or both, from the retrieved one or more vector representations, corresponding to the received natural language query.

In still more embodiments, the process 1000 may generate an augmented query (for example, augmented query 510 or 616) in a hierarchical query language (block 1040). The augmented query may be generated based on the identified semantically augmented linear paths and the received natural language query. In still further embodiments, an AI-based model such as, LLM (for example, LLM 508 or 612) may be utilized to generate the augmented query. The hierarchical query language may be associated with the hierarchical data model. In still additional embodiments, the process 1000 may output the augmented query in response to the received natural language query. In some more embodiments, the process 1000 may search the hierarchical data model based on the augmented query. In yet more embodiments, the process 1000 may output the search result from the hierarchical data model in response to the received natural language query.

Although a specific embodiment for generating an augmented query in a hierarchical query language from a natural language query suitable for carrying out the various steps, processes, methods, and operations described herein is discussed with respect to FIG. 10, any of a variety of systems and/or processes may be utilized in accordance with embodiments of the disclosure. For example, the process 1000 may be adapted for use in any language other than hierarchical query language. The elements depicted in FIG. 10 may also be interchangeable with other elements of FIGS. 1-9 and FIGS. 11-12 as required to realize a particularly desired embodiment.

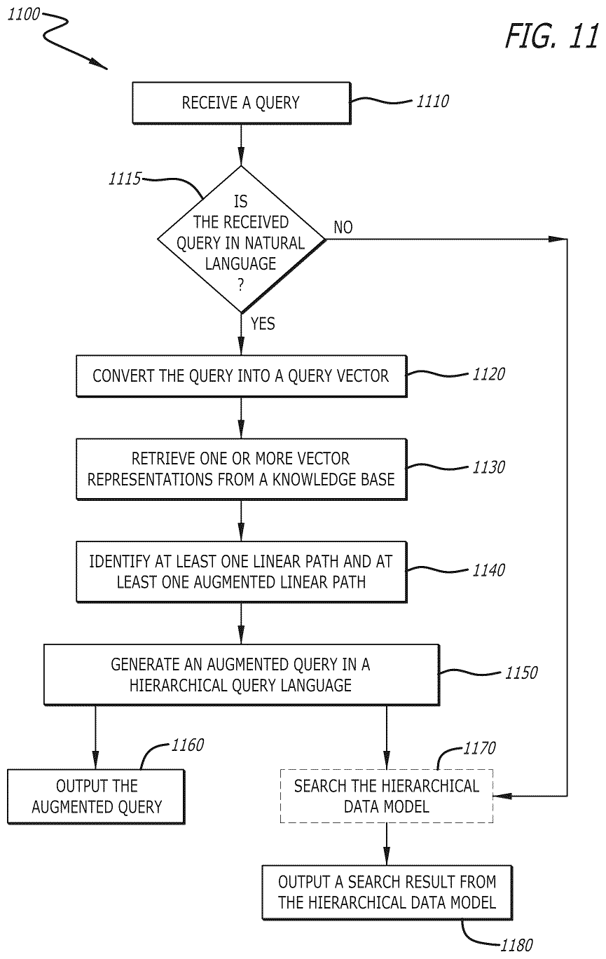

Referring to FIG. 11, a flowchart depicting a process 1100 for generating an augmented query associated with a query management device (for example, LLM-driven device 602) in accordance with various embodiments of the disclosure is shown. In many embodiments, the process 1100 may receive a query (block 1110). The query may be received from a user or an external system or service.

In a variety of embodiments, the process 1100 may determine if the received query is in natural language (block 1115). In more embodiments, the process 1100 may classify the query as a natural language query if the query comprises syntactically complete phrases or sentences consistent with human language patterns, as opposed to formal query languages (e.g., XPath, SQL, or CLI commands). In an example, natural language sentences include interrogatives, verbs, and other linguistic markers not present in structured query syntax. In still more embodiments, the process 1100 may utilize a language detection module to analyze a structure and token distribution of the received query. The language detection module may apply pattern matching, rule-based heuristics, or a trained classifier (e.g., a shallow neural network or decision tree) to determine whether the received query conforms to natural language characteristics. For example, the process 1100 may check for the presence of stop words, sentence structure patterns, or named entity phrases, and assign a confidence score indicating whether the received query is likely to be in natural language.

If the received query is not in natural language, for example, is in structured or hierarchical query language, in yet more embodiments, the process 1100 may search a hierarchical data model (block 1120). The process 1100 may search the hierarchical data model based on the received query. In a number of embodiments, the process 1100 may search any other data store configured to output a result for the received query. For example, the hierarchical data model may reference to other data stores to obtain a valid result to the received query.

In still yet more embodiments, the process 1100 may output a search result from the hierarchical data model (block 1130). The search result may be provided to the user or the external system or service via a query interface (for example, query interface 608). In one or more embodiments, when the received query is expressed in a hierarchical query language (for example, a path-based expression referencing specific containers, lists, or leaf nodes of the hierarchical data model), the process 1100 may parse the received query and identify matching nodes within the hierarchical data model. The search result may include a resolved subtree or set of node definitions corresponding to the query.

In additional embodiments, at block 1115, if the query is in natural language, the process 1100 may convert the query into a query vector (for example, query vector 504) (block 1140). The natural language query may be converted by a query processing engine (for example, the query processing engine 610) for use in performing search in a knowledge base (for example, knowledge base 506). In an example, the query vector may correspond to an embedding vector.

In further embodiments, the process 1100 may retrieve one or more vector representations from a knowledge base (for example, knowledge base 506) (block 1150). The knowledge base may include vector representations constructed from flattened and semantically augmented linear paths of the hierarchical data model. Each vector representation may be associated with a specific linear path associated with the hierarchical data model. In additional embodiments, the process 1100 may perform a similarity search in the knowledge base between the query vector and the stored vector representation data (for example, vector representation data 506-3) and retrieve the one or more vector representations that are most similar to the query vector. In an example, the one or more vector representations may correspond to a set of semantically augmented linear paths of the hierarchical data model (for example, hierarchical data model 700).

In still more embodiments, the process 1100 may identify at least one linear path and at least one augmented linear path (block 1160). The process 1100 may identify the at least one linear path and the at least one augmented linear path based on the retrieved one or more vector representations.

In still additional embodiments, the process 1100 may generate an augmented query (for example, augmented query 510 or 616) in a hierarchical query language (block 1170). The process 1100 may generate the augmented query based on the identified at least one linear path, the identified at least one augmented linear path, or both, and the received natural language query. In still further embodiments, the process 1100 may utilize an AI-based model such as, LLM (for example, LLM 508 or 612) to generate the augmented query. The hierarchical query language may be associated with the hierarchical data model.

In some more embodiments, the process 1100 may output the augmented query (block 1180). For example, the augmented query may be provided to the user or the external system or service for further handling. The augmented query may be provided via the query interface 608. In several embodiments, the process 1100 may search the hierarchical data model (block 1120) and output the search result from the hierarchical data model (block 1130) based on the augmented query.

Although a specific embodiment for generating an augmented query associated with a query management device suitable for carrying out the various steps, processes, methods, and operations described herein is discussed with respect to FIG. 11, any of a variety of systems and/or processes may be utilized in accordance with embodiments of the disclosure. For example, the process 1100 may be utilized for translating a natural language query into one of a plurality of hierarchical query languages selected by a user. For instance, the process 1100 may prompt the user to select one of the plurality of hierarchical query languages for translating the natural language query. The elements depicted in FIG. 11 may also be interchangeable with other elements of FIGS. 1-9 and FIG. 12 as required to realize a particularly desired embodiment.

Referring to FIG. 12, a conceptual block diagram of a device 1200 suitable for configuration with a query management logic 1224 for implementing the functionality and various embodiments of the disclosure is shown.

The embodiment of the device 1200 in the conceptual block diagram depicted in FIG. 12 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1200 may, in some examples, correspond to a physical device or to a virtual resource described herein. The device 1200 can be a network device, for example, an access point, a router, a switch, any type of edge-based network device, or the like in accordance with various embodiments of the disclosure.

In many embodiments, the device 1200 may include an environment 1202 such as a baseboard or a “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In a number of embodiments, one or more processors 1204, such as, but not limited to, CPUs can be configured to operate in conjunction with a chipset 1206. The processor(s) 1204 can be standard programmable CPUs that perform arithmetic and logical operations necessary for the operation of the device 1200.

In a variety of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a Random-Access Memory (RAM) 1208, which can be utilized as the main memory in the device 1200 in some embodiments. The chipset 1206 can further be configured to provide an interface to a computer-readable storage medium such as a Read-Only Memory (ROM) 1210 or a Non-Volatile RAM (NVRAM) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the LAN 1240. The chipset 1206 can include functionality for providing network connectivity through a Network Interface Controller (NIC) 1212, which may include a gigabit Ethernet adapter or similar component. The NIC 1212 can be capable of connecting the device 1200 to other devices over the LAN 1240. It is contemplated that multiple NICs 1212 may be present in the device 1200, connecting the device 1200 to other types of networks and remote systems.

In more embodiments, the device 1200 can be connected to a storage 1218 that provides non-volatile storage for data accessible by the device 1200. The storage 1218 can, for example, store an operating system 1220, programs 1222 (e.g., applications), semantic data 1228, linear path data 1230, vector data 1232, and a hierarchical data model 1234, which are described in greater detail below. The storage 1218 can be connected to the environment 1202 through a storage controller 1214 connected to the chipset 1206. In additional embodiments, the storage 1218 can include one or more physical storage units. The storage controller 1214 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1200 can store data within the storage 1218 by transforming the physical state of the physical storage units to reflect the information being stored. The specific transformation of the physical state can depend on various factors. Examples of such factors can include, but are not limited to, the technology utilized to implement the physical storage units, whether the storage 1218 is characterized as primary or secondary storage, and the like. For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, or any components included therein, may be supported by one or more devices similar to the device 1200. Stated otherwise, some or all of the operations performed by the cloud computing network, or any components included therein, may be performed by the device 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1218 can store an operating system 1220 utilized to control the operation of the device 1200. According to one embodiment, the operating system 1220 includes the LINUX operating system. According to another embodiment, the operating system 1220 includes the Windows® server operating system from Microsoft Corporation of Redmond, Washington. According to further embodiments, the operating system 1220 can include the UNIX operating system or one of its variants. It should be appreciated that other operating systems can also be utilized. The storage 1218 can store other system or application programs and data utilized by the device 1200.

In still more embodiments, the storage 1218 or other computer-readable storage media is encoded with computer-executable instructions which, when loaded into the device 1200, may transform the device 1200 from a general-purpose computing system into a special-purpose computer capable of implementing the embodiments described herein. These computer-executable instructions may be stored as programs 1222 (e.g., applications) and transform the device 1200 by specifying how the processor(s) 1204 can transition between states, as described above. In still further embodiments, the device 1200 has access to computer-readable storage media storing computer-executable instructions which, when executed by the device 1200, perform the various processes described above with regard to FIGS. 1-11. In still additional embodiments, the device 1200 can also include computer-readable storage media having instructions stored thereupon for performing any of the other computer-implemented operations described herein.

In some more embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 may not include all of the components shown in FIG. 12, and can include other components that are not explicitly shown in FIG. 12, or may utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In yet various embodiments, the device 1200 can include the query management logic 1224 that may be configured to summarize the hierarchical data model 1234, and converting a natural language query into an augmented query in a hierarchal query language associated with the hierarchical data model 1234. In yet more embodiments, the query management logic 1224 may operate in an AI-based query management device, for example, an LLM-driven query management device (e.g., the device 1200). The query management logic 1224 can be configured to perform various operations such as, but not limited to, flattening the hierarchical data model 1234 into a plurality of linear paths, augmenting the linear paths with semantic data 1228, encoding the augmented linear paths into a set of vector representations or vector data 1232, storing the vector data 1232, receiving a natural language query, converting the natural language query into a query vector, retrieving one or more vector representations from the vector data 1232, generating an augmented query, and outputting the augmented query. In still yet more embodiments, the query management logic 1224 can be configured to perform various operations such as, but not limited to, identifying a linear path and a semantically augmented linear path from the retrieved one or more vector representations, outputting a search result from the hierarchical data model 1234 based on the augmented query, or the like.

Those skilled in the art will recognize that the query management logic 1224 can include various hardware and/or software deployments and can be configured in a variety of ways. In many additional embodiments, the query management logic 1224 can be configured as a standalone device, exist as a logic in another network device, be distributed among various network devices operating in tandem, or remotely operated as part of a cloud-based network management tool. In still yet further embodiments, one or more servers can be configured with the query management logic 1224 or can otherwise operate as the query management logic 1224. In still yet additional embodiments, the query management logic 1224 may operate on one or more servers connected to a communication network, for example, the Internet. The communication network can include wired networks or wireless networks. The query management logic 1224 can be provided as a cloud-based service that can service remote networks, such as, but not limited to, a deployed network. Further, in several embodiments, the query management logic 1224 may be operated as a distributed logic across multiple network devices. In an embodiment, the controller can operate as the query management logic 1224 or may have multiple devices operate as the query management logic 1224 in a distributed manner.

In further additional embodiments, the storage 1218 can include the semantic data 1228. The semantic data 1228 may relate to data derived from the hierarchical data model 1234 utilized to enrich the plurality of linear paths obtained by flattening the hierarchical data model 1234. The plurality of linear paths may be augmented with the semantic data 1228 to generate semantically augmented linear paths. In an example, the query management logic 1224 may derive the semantic data 1228 from the hierarchical data model 1234. In various embodiments, the semantic data 1228 may include at least one of: node descriptions, node metadata, or hierarchical node positions, of the plurality of nodes of the hierarchical data model 1234. In an example, the metadata may include node types, data types, operational attributes, and configuration flags, of the plurality of nodes of the hierarchical data model 1234. Examples of the operational attributes may include access permissions (e.g., read-only, read-write), constraint rules (e.g., range, pattern, or enumeration constraints), or the like. In various embodiments, the configuration flags may characterize the behavior or attributes of specific nodes within the hierarchical data model 1234. Such flags may include, for example, an “is-configurable” flag indicating whether a node supports configuration operations, an “is-operational” flag specifying whether a node provides runtime or state data, a “mandatory” flag denoting that a node is required for schema conformance, and a “deprecated” flag indicating that a node should no longer be used in future configurations. Additional flags may include “is-leaf-list”, “is-container”, or “is-choice” to capture node types, or “is-key” to identify list keys used in path resolution. In additional embodiments, the semantic data 1228 may include structural context, such as parent-child relationships, list key identifiers, module or namespace identifiers, and grouping or feature inclusion information of the plurality of nodes of the hierarchical data model 1234. In one or more embodiments, the semantic data 1228 may also include usage annotations or intent tags derived from documentation or operational context, such as whether a node of the hierarchical data model 1234 is used in provisioning, telemetry, or policy configuration.

In several more embodiments, the storage 1218 can include the linear path data 1230. The linear path data 1230 may relate to data corresponding to the plurality of linear paths obtained by flattening the hierarchical data model 1234. For example, the hierarchical data model 1234 may be recursively traversed to obtain the linear path data 1230. Thus, the linear path data 1230 may include various fully qualified path strings, each representing a unique traversal route from one root node of the hierarchical data model 1234 to a specific leaf or container node of the hierarchical data model 1234.

In many embodiments, the storage 1218 can include vector data 1232. The vector data 1232 may relate to a set of vector representations corresponding to semantically augmented linear paths, a set of query vectors corresponding to the natural language query, or both. For example, the vector data 1232 may refer to embeddings that may be generated by encoding the semantically augmented linear paths.

In a variety of embodiments, data may be processed into a format usable by an ML model(s) 1226 (e.g., feature vectors), and/or other pre-processing techniques. The ML model(s) 1226 may be any type of ML model(s), such as supervised models, reinforcement models, and/or unsupervised models. The ML model(s) 1226 may include one or more of linear regression models, logistic regression models, decision trees, Naïve Bayes models, neural networks, k-means cluster models, random forest models, and/or other types of ML models. The ML model(s) may include an LLM, an LAM, or the like. In various embodiments, the ML model(s) 1226 may be configured to analyze the linear path data 1230, the vector data 1232, or both for generating an augmented query in a hierarchical query language.

Although a specific embodiment for a device 1200 suitable for configuration with the query management logic 1224 for carrying out the various steps, processes, methods, and operations described herein is discussed with respect to FIG. 12, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the query management logic 1224 acts in tandem between the devices. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A device, comprising:
one or more processors; and
a memory communicatively coupled to the one or more processors, wherein the memory comprises:
a hierarchical data model including a plurality of nodes, wherein the plurality of nodes comprises a root node and a terminal node; and
a query management logic configured to:
recursively traverse the hierarchical data model to flatten the hierarchical data model into a plurality of linear paths, wherein a linear path of the plurality of linear paths represents a unique traversal from the root node to the terminal node;
augment the plurality of linear paths with semantic data;
encode one or more augmented linear paths of the augmented plurality of linear paths into a set of vector representations; and
store the set of vector representations in a knowledge base.

2. (canceled)

3. (canceled)

4. The device of claim 1, wherein to augment the plurality of linear paths with the semantic data, the query management logic is further configured to derive the semantic data from the hierarchical data model.

5. The device of claim 4, wherein the semantic data comprises at least one of: node descriptions, node metadata, or hierarchical node positions, of the plurality of nodes.

6. The device of claim 5, wherein the node metadata comprises at least one of: node types, data types, operational attributes, and configuration flags, of the plurality of nodes.

7. The device of claim 1, wherein the knowledge base corresponds to an embedding vector database.

8. The device of claim 1, wherein the query management logic is further configured to:
receive a natural language query;
convert the natural language query into a query vector;
retrieve one or more vector representations from the set of vector representations stored in the knowledge base based on the query vector; and
identify, based on the retrieved one or more vector representations, at least one linear path of the plurality of linear paths and at least one augmented linear path of the augmented plurality of linear paths, corresponding to the received natural language query.

9. The device of claim 8, wherein the query management logic is further configured to generate, via a large language model, an augmented query in a hierarchical query language associated with the hierarchical data model based on the received natural language query and at least one of the identified at least one linear path or the identified at least one augmented linear path.

10. The device of claim 9, wherein the query management logic is further configured to output the augmented query in the hierarchical query language in response to the received natural language query.

11. The device of claim 9, wherein the query management logic is further configured to output, based on the augmented query, a search result from the hierarchical data model for the received natural language query.

12. The device of claim 9, wherein the query management logic is further configured to:
search the hierarchical data model based on the augmented query; and
output a search result for the received natural language query based on the search.

13. A device, comprising:
one or more processors; and
a memory communicatively coupled to the one or more processors, wherein the memory comprises:
a hierarchical data model including a plurality of nodes, wherein the plurality of nodes comprises a root node and a terminal node; and
a query management logic configured to:
receive a natural language query;
convert the natural language query into a query vector;
retrieve one or more vector representations from a knowledge base based on the query vector, wherein the one or more vector representations correspond to a set of semantically augmented linear paths of the hierarchical data model, and wherein a semantically augmented linear path of the set of semantically augmented linear paths represents a unique traversal from the root node to the terminal node; and
generate, via an artificial intelligence-based model, an augmented query in a hierarchical query language associated with the hierarchical data model based on the set of semantically augmented linear paths and the received natural language query.

14. The device of claim 13, wherein to generate the augmented query, the query management logic is further configured to identify the set of semantically augmented linear paths based on the retrieved one or more vector representations.

15. The device of claim 13, wherein the artificial intelligence-based model corresponds to a large language model.

16. The device of claim 13, wherein the query management logic is further configured to output the augmented query in the hierarchical query language in response to the received natural language query.

17. The device of claim 13, wherein the query management logic is further configured to output, based on the augmented query, a search result from the hierarchical data model for the received natural language query.

18. The device of claim 13, wherein the query management logic is further configured to:
search the hierarchical data model based on the augmented query; and
output a search result for the received natural language query based on the search.

19. A method, comprising:
recursively traversing a hierarchical data model including a plurality of nodes to flatten the hierarchical data model into a plurality of linear paths, wherein the plurality of nodes comprises a root node and a terminal node, and wherein a linear path of the plurality of linear paths represents a unique traversal from the root node to the terminal node;
augmenting the plurality of linear paths with semantic data;
encoding one or more augmented linear paths of the augmented plurality of linear paths into a set of vector representations; and
storing the set of vector representations in a knowledge base.

20. The method of claim 19, further comprising:
receiving a natural language query;
converting the natural language query into a query vector;
retrieving one or more vector representations from the set of vector representations stored in the knowledge base based on the query vector;
identifying, based on the retrieved one or more vector representations, at least one linear path from the plurality of linear paths and at least one augmented linear path of the augmented plurality of linear paths, corresponding to the received natural language query; and
generating, via a large language model, an augmented query in a hierarchical query language associated with the hierarchical data model based on the received natural language query and at least one of the identified at least one linear path or the identified at least one augmented linear path.
